(19) United States
(12) Patent Application Publication
(10) Pub. No.: US 2026/0147921 A1
(43) Pub. Date: May 28, 2026

(54) ELECTRONIC DEVICE, METHOD, AND NON-TRANSITORY COMPUTER READABLE STORAGE MEDIUM FOR GENERATING MESSAGE

(71) Applicant: Samsung Electronics Co., Ltd., Suwon-si (KR)

(72) Inventors: Minchul SHIN, Suwon-si (KR); Kihoon NAM, Suwon-si (KR); Seunggyu KONG, Suwon-si (KR); Sangheon KIM, Suwon-si (KR); Jeongseob KIM, Suwon-si (KR); Jinseok KIM, Suwon-si (KR); Sangeun YUK, Suwon-si (KR)

(21) Appl. No.: 19/178,289

(22) Filed: Apr. 14, 2025

Related U.S. Application Data
(63) Continuation of application No. PCT/KR2025/004703, filed on Apr. 7, 2025.

(30) Foreign Application Priority Data
Jul. 8, 2024 (KR) 10-2024-0089497
Aug. 27, 2024 (KR) 10-2024-0115450

(51) Int. Cl. G06F 21/62; G06F 16/3332; G06F 16/34

(52) U.S. Cl. CPC G06F 21/6245; G06F 16/3334; G06F 16/345

(57) ABSTRACT

According to an embodiment, an electronic device identifies an event for generating a response. Based on identifying the event, the electronic device generates a prompt to replace information associated with a second storage area different from a first storage area of memory, with a keyword. The electronic device provides the prompt to a trained model configured to be able to access, among the first storage area or the second storage area of the memory, the first storage area. The electronic device obtains a first response generated according to the prompt, from the trained model. The electronic device generates a second response by replacing the keyword included in the first response with privacy information in the second storage area of the memory.

### CROSS-REFERENCE TO RELATED APPLICATION(S)

This application is a continuation application, claiming priority under 35 U.S.C. § 365(c), of an International application No. PCT/KR 2025/004703, filed on Apr. 7, 2025, which is based on and claims the benefit of a Korean patent application number 10-2024-0089497, filed on Jul. 8, 2024, in the Korean Intellectual Property Office, and of a Korean patent application number 10-2024-0115450, filed on Aug. 27, 2024, in the Korean Intellectual Property Office, the disclosure of each of which is incorporated by reference herein in its entirety.

### TECHNICAL FIELD

The disclosure relates to an electronic device, a method, and a non-transitory computer readable storage medium for generating a message.

### BACKGROUND ART

Various contents (e.g., texts and an image) may be provided through an electronic device. The contents may be received from another electronic device, or may be provided to a user or transmitted to the other electronic device by being generated through the electronic device.

For example, a software application and/or a service utilizing artificial intelligence are being distributed. The user may obtain content having at least one form of a natural language (e.g., texts and/or an audio signal), an image, and/or a video by executing the software application and/or the service.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer readable storage medium for generating a message.

Additional aspects will be set forth in part in the description which follows and, in part, will be apparent from the description, or may be learned by practice of the presented embodiments.

In accordance with an aspect of the disclosure, an electronic device is provided. The electronic device may comprise memory comprising one or more storage mediums and storing instructions, and at least one processor including processing circuitry. The instructions, when executed by the at least one processor individually or collectively, may cause the electronic device to identify an event for generating a response. The instructions, when executed by the at least one processor individually or collectively, may cause the electronic device to, based on identifying the event, generate a prompt to replace information associated with a second storage area different from a first storage area of the memory, with a keyword. The instructions, when executed by the at least one processor individually or collectively, may cause the electronic device to provide the prompt to a trained model in the electronic device configured to be able to access, among the first storage area or the second storage area of the memory, the first storage area. The instructions, when executed by the at least one processor individually or collectively, may cause the electronic device to obtain a first response generated according to the prompt, from the trained model. The instructions, when executed by the at least one processor individually or collectively, may cause the electronic device to generate a second response by replacing the keyword included in the first response with privacy information in the second storage area of the memory.

According to an embodiment, an electronic device may comprise memory comprising one or more storage mediums and storing instructions, and at least one processor including processing circuitry. The instructions, when executed by the at least one processor individually or collectively, may cause the electronic device to provide a chatting session in which at least one message exchanged between a first user of the electronic device and a second user of another electronic device is displayed. The instructions, when executed by the at least one processor individually or collectively, may cause the electronic device to, in response to a first request, obtain a first message to be transmitted to the another electronic device from a first model, by inputting the at least one message to the first model set to generate character strings based on the provided input. The instructions, when executed by the at least one processor individually or collectively, may cause the electronic device to, at least based on determination that the first message includes a preset identifier, display a second message in which the preset identifier is replaced with privacy information stored in the electronic device. The instructions, when executed by the at least one processor individually or collectively, may cause the electronic device to, in response to a second request, transmit, to the another electronic device, the second message through the chatting session.

In an embodiment, a method of an electronic device may be provided. The method may comprise providing a chatting session in which at least one message exchanged between a first user of the electronic device and a second user of another electronic device is displayed. The method may comprise, in response to a first request, obtaining a first message to be transmitted to the another electronic device from a first model, by inputting the at least one message to the first model set to generate character strings based on the provided input. The method may comprise, at least based on determination that the first message includes a preset identifier, displaying a second message in which the preset identifier is replaced with privacy information stored in the electronic device. The method may comprise, in response to a second request, transmitting, to the another electronic device, the second message through the chatting session.

In an embodiment, a non-transitory computer-readable storage medium for storing instructions may be provided. The instructions, when executed by an electronic device including memory, may cause the electronic device to identify a user request. The instructions, when executed by the electronic device, may cause the electronic device to generate a response with respect to the user request, and generate a prompt to replace inaccessible information to be included in the response with a keyword. The instructions, when executed by the electronic device, may cause the electronic device to provide the prompt to a trained model in the electronic device configured to be able to access a first storage area of the memory. The instructions, when executed by the electronic device, may cause the electronic device to obtain a first response generated according to the prompt, from the trained model. The instructions, when executed by the electronic device, may cause the electronic device to generate a second response by replacing the keyword included in the first response with privacy information in a second storage area of the memory.

In an embodiment, a non-transitory computer-readable storage medium for storing instructions may be provided. The instructions, when executed by an electronic device including memory, may cause the electronic device to perform operations. The operations may include providing a chatting session in which at least one message exchanged between a first user of the electronic device and a second user of another electronic device is displayed, in response to a first request, obtaining a first message to be transmitted to the another electronic device from a first model, by inputting the at least one message to the first model set to generate character strings based on the provided input, at least based on determination that the first message includes a preset identifier, displaying a second message in which the preset identifier is replaced with privacy information stored in the electronic device, and in response to a second request, transmitting to the another electronic device the second message through the chatting session.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an operation of an electronic device that generates a response including privacy information in response to a user request according to an embodiment of the disclosure;

FIG. 2 illustrates a block diagram of an electronic device according to an embodiment of the disclosure;

FIG. 3 illustrates a flowchart of an electronic device according to an embodiment of the disclosure;

FIG. 4 illustrates an operation of an electronic device for inputting a prompt to a trained model according to an embodiment of the disclosure;

FIG. 5 illustrates a user interface (UI) displayed by an electronic device that generates a response with respect to a user request according to an embodiment of the disclosure;

FIG. 6 illustrates a UI of an electronic device displaying a response generated using a trained model according to an embodiment of the disclosure;

FIG. 7 schematically illustrates a block diagram with respect to programs executed by an electronic device according to an embodiment of the disclosure;

FIGS. 8A and 8B illustrate a UI displayed by an electronic device according to various embodiments of the disclosure;

FIG. 9 is a block diagram of an electronic device in a network environment according to an embodiment of the disclosure; and

FIG. 10 is a schematic diagram of an artificial intelligence (AI) system according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

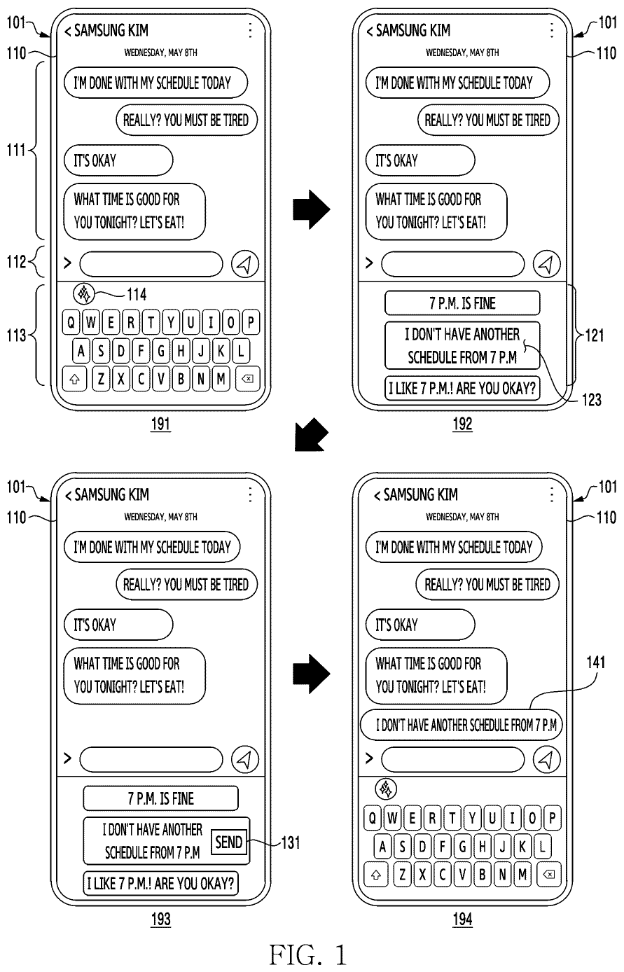

FIG. 1 illustrates an operation of an electronic device 101 that generates a response including privacy information in response to a user request according to an embodiment of the disclosure.

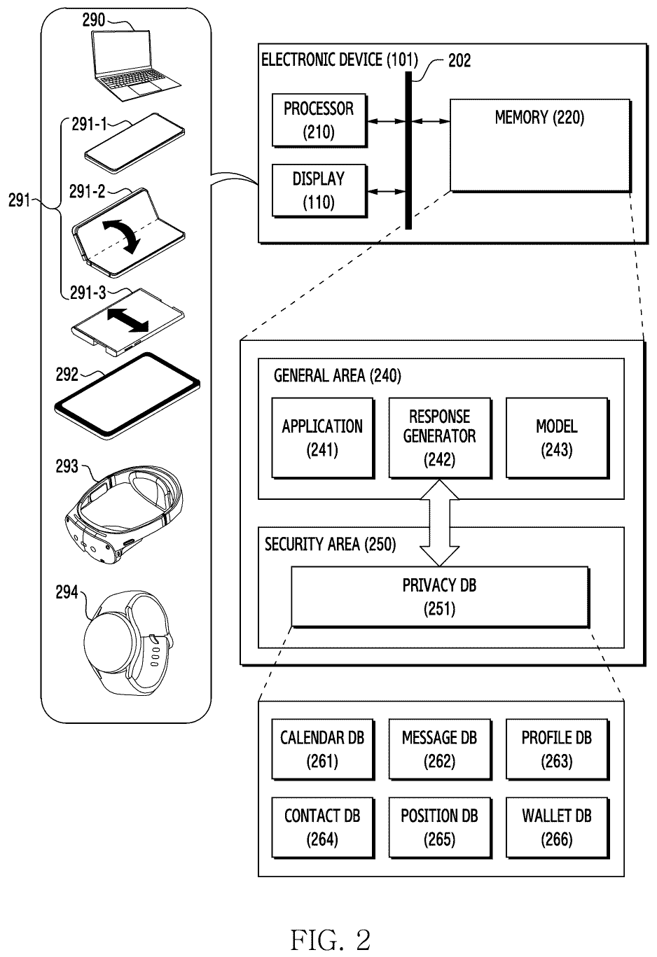

Referring to FIG. 1, states 191, 192, 193, and 194 of the electronic device 101 including a display 110 are illustrated. A hardware configuration of the electronic device 101 and/or form factors of the electronic device 101 will be described with reference to FIG. 2.

The electronic device 101 according to an embodiment may provide a function based on artificial intelligence. The artificial intelligence may be described as a technology simulating a neural activity (e.g., a training activity, a cognitive activity, a reasoning activity, and/or a creative activity) of a living organism (e.g., a human). In the disclosure, an artificial intelligence model and/or a model may include a computational model configured to simulate neural activity based on the artificial intelligence, a software application (e.g., an agent) designed to drive the computational model, hardware (e.g., a neural processing unit (NPU), a graphic processing unit (GPU), and/or a central processing unit (CPU)) configured to perform computations indicated by the computational model, or any combinations thereof.

According to an embodiment, the electronic device 101 may provide a function based on the artificial intelligence using a computational model trained to output a response (e.g., texts, audio, an image, and/or a video based on a natural language) with respect to a user request. For example, the electronic device 101 may respond to the user request and obtain at least one natural language sentence, an emoticon, or any combination thereof by using the computational model. Training of the computational model may be performed (before being installed in the electronic device 101) based on training data, referred to as a ground truth. The training of the computational model may be performed by a training algorithm such as forward propagation and/or backward propagation. The computational model may indicate a plurality of computations tuned by a training algorithm, such as an attention mechanism, regression, a decision tree, and/or a k-nearest neighborhood.

The computational model executed by the electronic device 101 according to an embodiment may have a structure designed to simulate the neural activity. For example, the computational model may have a structure referred to as a transformer (or encoder-decoder structure). For example, the computational model may have a structure such as a convolutional model, a feedforward model, a recurrent neural network (RNN), and/or a Markov chain. An embodiment is not limited thereto, and the computational model may include a combination of computational models based on any one of the exemplified structures.

The computational model executed by the electronic device 101 according to an embodiment may include a large language model (LLM) (or a language model). The LLM may include a computational model trained based on a large amount of natural language-based information through pre-learning. The LLM may have a transformer structure trained based on the attention mechanism. The LLM may have a structure such as Bidirectional Encoder Representations from Transformer (BERT), and/or generative pre-trained transformer (GPT). A transformer structure of the computational model may include an encoder that outputs reduced-dimensional information (e.g., contextual representation) with respect to information inputted to the computational model, and a decoder that outputs multi-dimensional information from the information. The encoder and the decoder may be interconnected based on a structure referred to as an attention-network and/or a cross-attention network. An embodiment is not limited thereto, and the computational model may include a large vision model (LVM), and/or a large multi-modal model (LMM).

For example, the computational model executed by the electronic device 101 may be configured to process information (e.g., a token) that represents meaning of a portion of a natural language (e.g., a word and/or a morpheme) based on a vector space, or output the information. The electronic device 101 may identify or obtain the output having a form of the natural language, by decoding the word and/or the natural language corresponding to the information outputted from the computational model using the vector space. The computational model may be trained by an algorithm such as self-supervised learning. The computational model installed in the electronic device 101 may be referred to as a trained model in terms of the trained computational model. Using the computational model, various natural language-based services such as a chatbot, a translation, and/or a summary may be provided by the electronic device 101.

In an embodiment, the trained model executed by the electronic device 101 may receive information referred to as a prompt (e.g., a set of at least one natural language sentence based on texts, texts in a format (e.g., one or more words, and/or a phrase) different from a sentence, an image, audio, a video, or any combination thereof). The trained model receiving the prompt based on the natural language sentence is exemplarily described, but an embodiment is not limited thereto. For example, the trained model may receive a prompt including multimedia data such as an image, audio (e.g., a speech and/or music), and/or a video. The electronic device 101 executing the artificial intelligence-based function may be configured to obtain a response satisfying a purpose and/or an intention of the function from the trained model using the prompt. The electronic device 101 according to an embodiment may control the trained model by using the prompt to be inputted to the trained model.

For example, since the trained model is trained to generate a response based on the natural language, the trained model executed by the electronic device 101 may generate a response including an obvious error. For example, when generating a response including information not used for training (e.g., personal information unique to a user of the electronic device 101 such as a schedule, a message, a profile, a contact, a position, and/or credit information), the response outputted from the trained model may include an error with respect to the information. A phenomenon in which the response including the error outputted from the trained model may be referred to as a hallucination.

For example, in order to enhance security of privacy information including personal information, the electronic device 101 may be designed such that the trained model has restricted access to the privacy information. For example, the electronic device 101 may manage the trained model to access specific information based on a preset rule or condition (e.g., a type of information, a type of a user account, or a type of a connected network). For example, the trained model may be designed such that at least a portion of the privacy information is inaccessible. In the disclosure, the privacy information may include the personal information as well as information of a specific category that is inaccessible by the trained model. According to an embodiment, some of a plurality of training models available through the electronic device 101 may be managed such that access to information of the specific category is restricted (e.g., inaccessible). In the example, when the electronic device 101 controls a model trained to generate a response based on the privacy information, a possibility of the hallucination occurring may increase.

For another example, the electronic device 101 may be configured to perform training on the trained model using stored privacy information as the privacy information is stored in the electronic device 101. In the example, the privacy information stored after training may cause the hallucination. For example, various information associated with the user or a specific account stored after training may correspond to information for processing a response of a training model as a keyword in the disclosure.

According to an embodiment, the electronic device 101 may input a prompt for generating a response without a prediction (or an error) with respect to information inaccessible by the trained model to the trained model, in order to reduce or prevent the hallucination. The electronic device 101 may finalize the response to be provided to the user, by inserting the personal information and/or the privacy information to the response generated from the trained model. For example, in order to perform post-processing with respect to the response obtained from the trained model, the electronic device 101 may input a prompt requesting a response suitable for the post-processing to the trained model.

Referring to FIG. 1, the states 191, 192, 193, and 194 of the electronic device 101 executing a function based on the trained model are illustrated. In the state 191, the electronic device 101 may display a user interface (UI) based on a text message (e.g., a short message service (SMS)) on the display 110. The UI displayed on the display 110 of FIG. 1 may be a screen (e.g., a messenger screen) displayed by a messenger application.

Referring to the state 191 of FIG. 1, a screen displayed on the display 110 may include a portion 111 (e.g., a browsing area) for displaying text messages exchanged between the user of the electronic device 101 and another user, a portion 112 (e.g., a composing area) for composing a text message to be transmitted to the other user, and/or a portion 113 (e.g., a virtual keyboard area) for receiving an input for the text message to be displayed in the portion 112. Based on the state 191 of FIG. 1, the electronic device 101 may provide a chatting session in which at least one text message exchanged between the user of the electronic device 101 and a counterpart is displayed.

In the state 191 of FIG. 1, the electronic device 101 may generate or provide an artificial intelligence-based response (e.g., the text message to be transmitted to the counterpart). Although an operation of the electronic device 101 based on the artificial intelligence is described, an embodiment is not limited thereto, and the electronic device 101 may include hardware, software, or any combination thereof that performs a function corresponding to the disclosure. For example, the electronic device 101 may identify a user request with respect to the response. For example, the electronic device 101 may identify the user request through a messenger screen displayed on the display 110. For example, in order to identify the user request, the electronic device 101 may display a visual object 114. The visual object 114 having a form of an icon (e.g., including at least one of an image or texts) may correspond to a function of recommending a response based on the chatting session using the artificial intelligence. Based on a touch gesture (e.g., a tap gesture) and/or a mouse click on the visual object 114, the electronic device 101 may obtain or generate candidate responses by executing the artificial intelligence. According to an embodiment, the function of recommending the response based on the chatting session may be executed based on an input (e.g., a voice input including a specific utterance, a specific touch input with respect to a screen) preset to execute an intelligent assistant (e.g., Samsung ® Bixby™).

Referring to FIG. 1, the electronic device 101 that receives an input to select the visual object 114 in the state 191 may switch to the state 192. The electronic device 101 that identifies the user request based on the visual object 114 may generate one or more responses suitable for the chatting session by controlling the trained model. Referring to FIG. 1, in the state 192, the electronic device 101 may display, on the display 110, a portion 121 including responses generated based on the trained model. In the portion 121, natural language sentences reflecting a situation indicated by text messages included in the chatting session may be listed. For example, in a state in which there are texts inputted by the user in the portion 112, the electronic device 101 that receives the input may generate or output one or more responses (e.g., a natural language sentence including a subject and/or content of the texts inputted to the portion 112) based on the texts inputted to the portion 112, by controlling the trained model using the texts inputted to the portion 112.

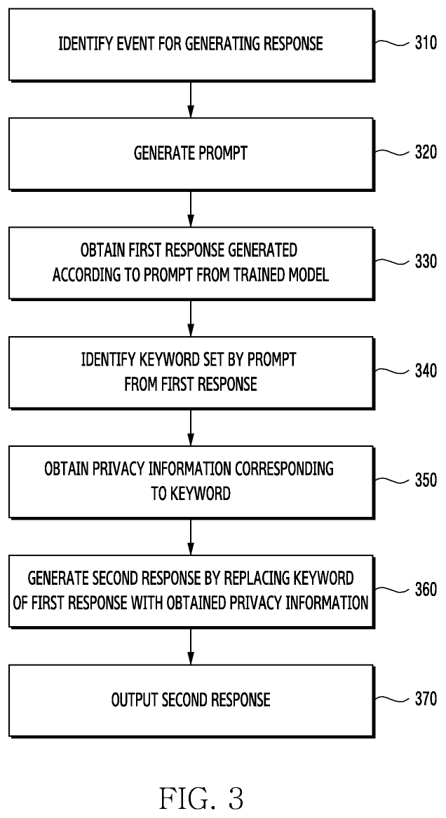

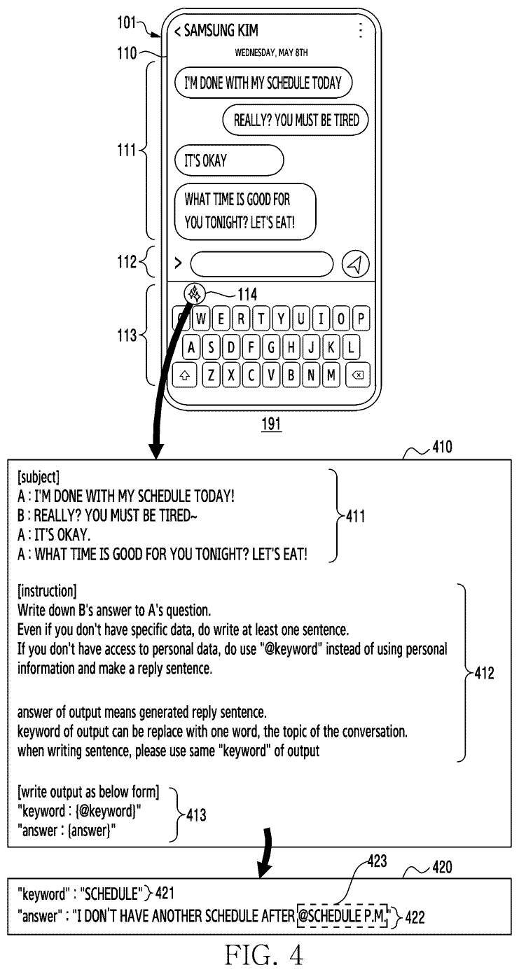

For example, in the state 191 in which the counterpart sends a text message to check an evening schedule of the user of the electronic device 101 (e.g., “What time is good for you tonight? Let's eat!”), the electronic device 101 that receives the input may obtain responses (e.g., “7 p.m. is fine,” “I don't have another schedule from 7 p.m. ,” and/or “I like 7 p.m.! Are you okay?”) including a natural language associated with the evening schedule using the trained model. An operation in which the electronic device 101 generates the responses based on the trained model will be described with reference to FIGS. 3, 4, and/or 7.

Referring to the state 192 of FIG. 1, each of the responses may have a selectable form (e.g., a button, and/or a text box) in the portion 121. The electronic device 101 may receive, through the portion 121, an input for transmitting at least one of the responses to the counterpart. For example, the electronic device 101 may receive a user input to select a visual object 123 (e.g., a button including “ I don't have another schedule from 7 p.m.”) corresponding to any one of the responses. The electronic device 101 that receives the user input may switch from the state 192 to the state 193.

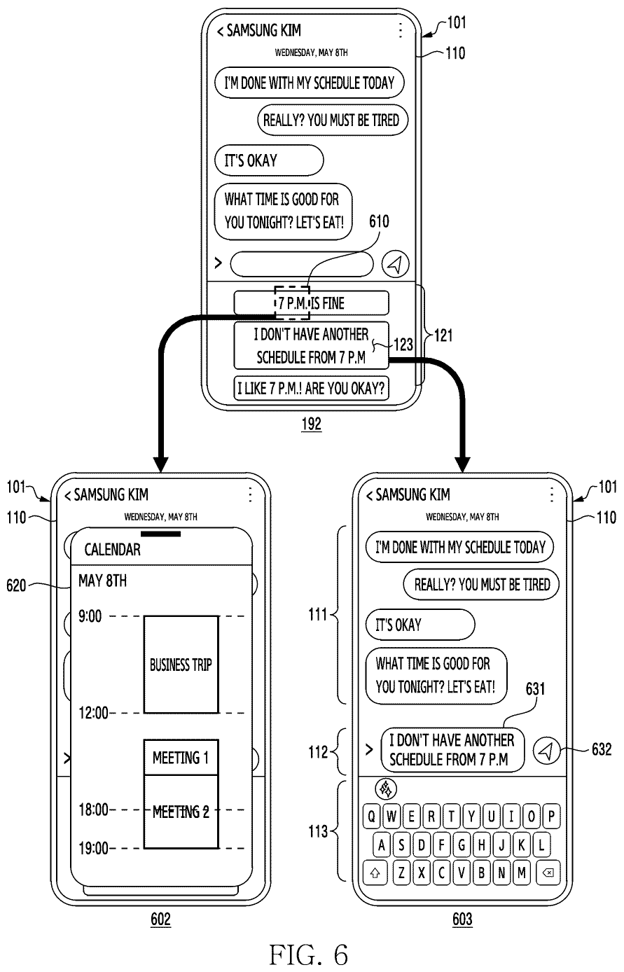

Referring to the state 193 of FIG. 1, the electronic device 101 may display a visual object 131 for transmitting texts (e.g., “ I don't have another schedule from 7 p.m.”) included in the visual object 123 together with the visual object 123. The visual object 131 having a form of a button including preset texts such as “Send” is illustrated as an example, but an embodiment is not limited thereto. For example, the electronic device 101 may receive an input to edit the texts or display another screen associated with the texts. For example, the electronic device 101 may receive an input to at least partially modify or remove the texts, or add an emoticon to the texts. An operation of the electronic device 101 that receives an additional input associated with the texts in the state 193 will be described with reference to FIG. 6.

In the state 193 of FIG. 1, the electronic device 101 that receives an input to select the visual object 131 may switch to the state 194. In response to the input, the electronic device 101 may transmit the texts (e.g., “ I don't have another schedule from 7 p.m.”) associated with the input to the counterpart (or an external electronic device to which the counterpart is logged in) of the chatting session. In the state 194, the electronic device 101 may display a visual object 141 representing the texts on the display 110. The visual object 141 may have a form of a bubble including the texts. The visual object 141 may be displayed together with other text messages exchanged between the user of the electronic device 101 and the counterpart in the portion 111. Referring to the states 192 and 193, the electronic device 101 may receive an input to select any one of a plurality of responses, and in response to the input, transmit a response (e.g., a text message) selected by the input to the counterpart.

As described above, in response to a user request for executing the artificial intelligence, the electronic device 101 according to an embodiment may generate a response based on a context (e.g., the chatting session) in which the user request has occurred and the privacy information with respect to the user of the electronic device 101. The electronic device 101 may generate the response using the trained model that is inaccessible to the privacy information. Since the trained model does not learn and/or access the privacy information, the security of the privacy information may be enhanced.

Hereinafter, a structure of the electronic device 101 for driving the trained model that is inaccessible to the privacy information will be described with reference to FIG. 2.

FIG. 2 illustrates a block diagram of an electronic device 101 according to an embodiment of the disclosure. Referring to FIG. 2, the electronic device 101 may be one of various types of electronic devices such as a laptop personal computer (PC) 290, smartphones 291 (e.g., a bar-type smartphone 291-1, a foldable-type smartphone 291-2, or a slidable (or rollable) type smartphone 291-3 described with reference to FIG. 1) having various form factors, a tablet PC 292, a head-mounted display (HMD) device 293, a watch 294, a cellular phone (not shown), and other similar computing devices (not shown).

In an embodiment, the electronic device 101 may be referred to as a mobile device, user equipment (UE) (or a user terminal), a multifunctional device, a portable communication device, a portable device, or a server. A form factor of the electronic device 101 is not limited to the form factors illustrated in FIG. 2. For example, the electronic device 101 may be included as an electronic control unit (ECU) in a vehicle (e.g., an electric vehicle (EV)). For example, the electronic device 101 may have a form factor wearable by a user, such as an earbud (or a wireless earphone) and/or a ring, or may have a form factor implantable on a body part of the user. For example, the electronic device 101 may have a form suitable for playing multimedia content.

Referring to FIG. 2, according to an embodiment, the electronic device 101 may include a processor 210 and/or memory 220. The electronic device 101 may further include a display 110. The processor 210 may be electrically and/or operatively coupled to the memory 220 and/or the display 110. Electronic components being electrically coupled may include a state in which a wired signal path (or connection for wireless communication) for transmission of a signal is established between the electronic components. The electronic components being operatively coupled may include a state in which the electronic components are directly coupled (or a state in which the electronic components are indirectly coupled) such that another electronic component is controlled by any one electronic component of the electronic components.

Referring to FIG. 2, for convenience of description, an electrical connection between the display 110, the processor 210, and the memory 220 is schematically illustrated. The processor 210 may be communicatively coupled to the display 110 and/or the memory 220 through one or more electronic components (e.g., a bus 202, and/or a communication bus 202). A wired interface for transmitting information may be established between the processor 210, the memory 220, and the display 110.

The processor 210 of FIG. 2 may include circuitry (e.g., processing circuitry and/or core) for performing a calculation (e.g., an arithmetic calculation and/or a logical calculation) with respect to data. A binary code (e.g., instruction) indicating the calculation may be inputted to the processor 210. The processor 210 may be referred to as an application processor (AP). The processor 210 may include a central processing unit (CPU), a graphic processing unit (GPU), and/or a neural processing unit (NPU). The processor 210 may include processing circuitry configured to perform functions indicated by instructions. The number of processors 210 included in the electronic device 101 may be one or more. At least one processor included in the electronic device 101 may be configured to execute instructions individually or collectively to perform an operation of the disclosure.

The memory 220 of FIG. 2 may include circuitry for storing data (or instructions) inputted to the processor 210 or outputted from the processor 210. The memory 220 may include volatile memory such as random-access memory (RAM) and/or non-volatile memory such as read-only memory (ROM). The non-volatile memory may be referred to as storage. The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), and an embedded multimedia card (eMMC). The memory 220 may include one or more storage media (e.g., the volatile memory and/or the non-volatile memory as described above) positioned in the electronic device 101 in a distributed manner. The processor 210 of the electronic device 101 may perform a function and/or an operation (e.g., operations of FIG. 3) indicated by the instructions, by executing the instructions of the memory 220 in the electronic device 101. For example, at least one processor of the electronic device 101, including the processor 210, may be configured to execute the instructions collectively or individually.

The display 110 of the electronic device 101 may include circuitry for visualizing information provided from the processor 210. The display 110 may include a liquid crystal display (LCD), a plasma display panel (PDP), and/or light emitting diodes (LEDs). The LED may include an organic LED (OLED). An embodiment is not limited thereto, and the display 110 may include electronic paper. A display area (or an active area) of the display 110 may include an area, through which light is emitted, formed by pixels (e.g., activated pixels) of the display 110. The display 110 may include a sensor (e.g., a touch sensor) for detecting an external object (e.g., a finger of a user) on the display 110. The sensor may be included in the display 110 in a form of a panel (e.g., a touch sensor panel (TSP)). The display 110 including the sensor may be referred to as a touch screen. The display 110 may further include a sensor (e.g., a digitizer based on electro-mechanical relays (EMR) and/or an active electrostatic solution (AES)) for detecting an external object such as a stylus.

Referring to FIG. 2, programs (e.g., a (software) application 241, a response generator 242, a model 243) stored in the memory 220 to be executed in the processor 210 and information (e.g., privacy DB 251) accessible by at least one of the programs are illustrated. The programs may be independently installed in the memory 220, or may be stored in the memory 220 as a sub-routine (or an applet or a dynamic link library (DLL)) of a single program.

The processor 210 of the electronic device 101 according to an embodiment may execute a function associated with artificial intelligence, or may provide a user experience associated with the artificial intelligence, by executing the application 241. The application 241 may include, in addition to the messenger application described with reference to FIG. 1, a conversational application based on voice recognition, an email, a social network service (SNS), a video streaming application, a podcast (for streaming audio), a word processor, online banking, and/or an editing application for media content (e.g., an image, a video, and/or audio).

According to an embodiment, the processor 210 of the electronic device 101 may perform computations associated with the artificial intelligence by executing the model 243. The model 243 may include a trained model, as described with reference to FIG. 1. An embodiment (e.g., on-device and/or standalone) in which the computations of the model 243 are performed directly by the processor 210 is described, but the embodiment is not limited thereto. For example, the electronic device 101 may transmit a signal to control the model 243 executed in an external electronic device to the external electronic device connected through communication circuitry. For example, an operation of executing the model 243 may include an operation of the processor 210 directly performing the computations of the model 243, as well as an operation of communicating with a server, and an operation of receiving information outputted from the model 243 of the server. For another example, the electronic device 101 may perform an operation of generating a summary of a chatting session and/or a prompt using a model in the electronic device 101, and may obtain a response including an emoticon from a model in the external electronic device or may perform an operation associated with a chatting session associated with three or more users, by communicating with the external electronic device through the communication circuitry. For example, the electronic device 101 may use the model in the electronic device 101 in case that only content in a form of text is required as a response, and use the model in the external electronic device in case that content such as an image, a video, and audio is required as a response. For example, the electronic device 101 may use the model in the external electronic device in case that a conversation, a topic, or a judgment of a speaker associated with a response is required in a multilateral conversation environment.

According to an embodiment, the processor 210 of the electronic device 101 may store information (e.g., privacy information) with respect to a user of the electronic device 101 in the privacy DB 251 of a security area 250. The privacy information inputted to the electronic device 101 may be stored in the privacy DB 251. The privacy information, which is personal information of the user of the electronic device 101, may include information that should not be disclosed to another user (without permission).

Referring to FIG. 2, the privacy DB 251 may be stored in the security area 250 of the memory 220. The security area 250 may be a portion of the memory 220 that is allowed to an authorized (or authenticated) user and/or program. For example, an unauthorized user and/or program may not be allowed to read, write, and/or update the security area 250. The information stored in the security area 250 may be encrypted. The processor 210 executing a program, which is allowed to access the security area 250, may decrypt the information (e.g., the privacy DB 251) stored in the security area 250.

Referring to FIG. 2, the privacy DB 251 may include DBs (e.g., calendar DB 261, message DB 262, profile DB 263, contact DB 264, position DB 265, and/or wallet DB 266) for storing various information associated with the user of the electronic device 101. In the calendar DB 261, information with respect to a schedule of the user of the electronic device 101 may be stored. In the message DB 262, information (e.g., an email, a text message, and/or a voice message) transmitted between the user of the electronic device 101 and another user may be stored. In the profile DB 263, personal information (e.g., a birthday, and the like) with respect to the user of the electronic device 101 may be stored. In the contact DB 264, a contact stored by the user of the electronic device 101 may be stored. In the position DB 265, position information stored by the user of the electronic device 101 may be stored. In the wallet DB 266, financial information of the user of the electronic device 101 may be stored. In the privacy DB 251, the privacy information of the user may be stored in a form of a vector and/or a record.

According to an embodiment, the electronic device 101 may update or manage the privacy DB 251 by using a contact, a schedule, an email, a messenger, and/or SNS information stored in the memory 220. The electronic device 101 may update the privacy DB 251 by using an image, a video, and/or audio stored in the memory 220 (e.g., object detection, optical character recognition (OCR), and/or speech-to-text (STT)). For example, the electronic device 101 may extract (e.g., extraction based on the OCR) a card number and/or an account number from an image, and store the extracted card number and/or account number as the privacy information. For example, the electronic device 101 may verify or identify when, where, with whom, and/or what the user of the electronic device 101 did as personal information by using information obtained from the image and/or the video using the OCR. The information stored in the privacy DB 251 may include information (e.g., a Wi-Fi service set identifier (SSID) and/or information for logging into a network) with respect to the network connected to the electronic device 101 and sensor data (e.g., a state of charge (SOC) of a battery, a position and/or movement speed indicated by a global positioning system (GPS), and/or health data, activity data, and/or sensor data of the user based on a biometric sensor such as a heart rate sensor) obtained by the electronic device 101. The information stored in the privacy DB 251 may include information (e.g., state information of the external electronic device, content displayed on the external electronic device, and activity information of the user) obtained from the external electronic device (e.g., a home appliance, a wearable device such as a HMD, and/or a vehicle).

Referring to FIG. 2, an embodiment in which the privacy DB 251 is generated in the memory 220 (and the security area 250 of the memory 220) of the electronic device 101 has been described, but an embodiment is not limited thereto. The privacy DB 251 may be stored in an external electronic device different from the electronic device 101. An operation of accessing the privacy DB 251 by the processor 210 may include not only an operation of accessing the privacy DB 251 stored in the security area 250 of the memory 220, but also an operation of communicating with the external electronic device in order to access the privacy DB 251 stored in memory of the external electronic device. For example, the processor 210 may identify the external electronic device in which the privacy DB 251 is stored based on account information logged into the electronic device 101, and may access the privacy DB 251 stored in the external electronic device by communicating with the identified external electronic device.

Referring to FIG. 2, the processor 210 may process a user request based on the privacy DB 251 and/or the model 243 by executing the response generator 242. The processor 210 may execute the response generator 242 to generate a response with respect to a user request identified through the application 241. The processor 210 executing the response generator 242 may generate a prompt for generating the response with respect to the user request. The processor 210 may generate a prompt for replacing information (e.g., the information stored in the privacy DB 251) inaccessible by the model 243 in the response with a keyword.

Referring to FIG. 2, the model 243, the application 241, and/or the response generator 242 may be stored in a general area 240 of the memory 220 different from the security area 250. The model 243 executed in the general area 240 may not access the security area 250. The processor 210 executing the response generator 242 may access at least a portion (e.g., the privacy DB 251) of the security area 250 in which access based on the response generator 242 is allowed. The processor 210 may execute the model 243 using a prompt generated by the response generator 242. Since access to the security area 250 based on the model 243 is not allowed, the processor 210 may generate or obtain a response that does not include information stored in the security area 250, by executing the model 243.

As described above, when a response associated with information that is not used for training (or inaccessible information) is generated by the model 243, a hallucination may occur. Since a prompt (e.g., the prompt generated by executing the response generator 242) inputted to the model 243 explicitly requests that the inaccessible information be represented as a keyword (e.g., fixed character strings), as described above, information outputted from the model 243 may include the keyword instead of the hallucination. For example, the processor 210 may obtain information without the hallucination from the model 243. Alternatively, in case of receiving information (e.g., texts including a number, a date, an account number, an address, and/or a phone number) that may cause the hallucination to occur from the model 243, the processor 210 may replace and/or change at least a portion of the information. For example, when information of a type classified as information that may occur the hallucination is verified, the processor 210 may compare it with the information of the DB 251 to determine whether they matches each other. For example, the processor 210 may change the at least a portion of the information based on the result of the comparison using the information included in the privacy DB 251. The processor 210 may display a portion where the hallucination may occur differently from another portion (e.g., apply effects such as underlining and/or italics, or change a font color and/or a font). The processor 210 may receive information from the model 243 that emphasizes the portion in which the hallucination may occur with respect to the other portion.

The processor 210 providing a prompt to the model 243 configured to be able to access the general area 240 of the memory 220 may obtain a first response generated according to the prompt from the model 243. The processor 210 may search for a keyword included in the first response to prevent the hallucination. The processor 210 executing the response generator 242 may replace the keyword included in the first response with the information (e.g., the privacy information in the privacy DB 251) in the security area 250. The processor 210 may generate a second response, by replacing the keyword included in the first response with the privacy information in the security area 250. The second response may be displayed on the display 110 by the processor 210, such as the responses displayed through the portion 121 in the state 192 of FIG. 1. The second response may be generated by the processor 210 executing the application 241, or may be used as content (e.g., texts) inputted to the processor 210 executing the application 241.

As described above, the processor 210 may at least partially change information generated by the model 243 by executing the response generator 242. For example, the processor 210 may change a portion that should be personalized to the user of the electronic device 101 in the information generated by the model 243. The processor 210 may at least partially change a natural language generated by the model 243 such that the natural language generated by the model 243 that has learned a large amount of natural language does not include inaccurate information with respect to the user. Since a response generated using the response generator 242 includes not only a result of recognizing a context by the model 243 but also all of the personal information of the user stored in the privacy DB 251, the response desired by the user may be provided more accurately. Since a response is generated using the model 243 with restricted (e.g., blocked) access to the personal information (e.g., the information stored in the privacy DB 251) of the user, a security problem occurring in the model 243 may also be solved.

Hereinafter, an operation of the processor 210 executing the response generator 242 will be described with reference to FIG. 3.

FIG. 3 illustrates a flowchart of an electronic device according to an embodiment of the disclosure. The electronic device 101 and/or the processor 210 of FIGS. 1 and 2 may perform operations of FIG. 3. An order in which the operations of FIG. 3 are performed is not limited to an order illustrated in FIG. 3. For example, the processor 210 of FIG. 2 may perform the operations of FIG. 3 differently from the order illustrated in FIG. 3. For example, the processor 210 of FIG. 2 may perform at least two of the operations of FIG. 3 substantially simultaneously.

Referring to FIG. 3, in an operation 310, the electronic device according to an embodiment may identify an event for generating a response. The event may include a user request for generating a response, or may be generated by the user request. The event may be generated when a message including texts is received from an external electronic device. The event may be generated by an input (e.g., an input to select a text input UI of a virtual keyboard) associated with the virtual keyboard. The event may be generated when displaying a message received by the electronic device (during a preset time). The user request of the operation 310 may include an input indicating to select the visual object 114 of FIG. 1. The user request of the operation 310 may be generated to obtain content generated by a trained model (e.g., the model 243 of FIG. 2). The user request of the operation 310 may be identified by a software application (e.g., the application 241 of FIG. 2) executed by the electronic device. The electronic device that identifies the user request of the operation 310 may perform remaining operations of FIG. 3. An embodiment is not limited thereto, and the electronic device may perform the remaining operations of FIG. 3 in response to detecting an event associated with the trained model.

Referring to FIG. 3, in an operation 320, the electronic device according to an embodiment may generate a prompt. For example, the electronic device may execute the response generator 242 of FIG. 2 to perform the operation 320. The prompt may include a sentence instructing to generate the response corresponding to the user request of the operation 310. The prompt may include a sentence instructing on a form (e.g., the maximum number of characters, a tone, and/or a format) of the response.

The prompt generated by the electronic device performing the operation 320 may include a sentence for reducing or preventing a hallucination. For example, in case of using a trained model that is inaccessible to privacy information, information different from the privacy information may be included in the content outputted from the trained model (i.e., occurrence of hallucination). The electronic device may add, in the prompt, a sentence instructing to indicate a portion to which the privacy information is to be inserted as a specific keyword (or an identifier, a marker, or an indicator). The electronic device may add a sentence instructing that at least one response among a plurality of responses does not include the privacy information.

The electronic device performing the operation 320 may generate a prompt including information, which may be referenced by the trained model executed to generate a response. For example, the electronic device that identifies a user request to generate a response based on a text message may generate a prompt that includes text messages (e.g., one or more text messages displayed through the portion 111 of FIG. 1) that have been exchanged between users. In the example, the electronic device may generate a prompt including text messages generated in a preset period (e.g., a period between a current time point and a week), the preset number (e.g., six) of text messages, and/or text messages with the preset number of characters. For example, the electronic device that identifies the user request through a first software application may generate a prompt using information (e.g., text messages exchanged between the users through a SMS) associated with the first software application as well as information (e.g., text messages exchanged between the users through the SNS) associated with a second software application. In order to transmit a large amount of information to the trained model, the electronic device may execute a summary function based on the trained model. For example, a prompt including a summary of the text messages generated in the preset period may be generated. When a length and/or a size of information to be included in a prompt exceeds a threshold, the electronic device may execute the summary function.

An example of generating the prompt based on the text message has been described, but an embodiment is not limited thereto. For example, the electronic device that identifies a user request to generate a response to be included in an email may generate a prompt including emails exchanged with a user preset as a recipient. For example, the electronic device may generate a prompt including texts and/or an image that were being displayed on a display (or a UI displayed on the display) at a time point of identifying the user request.

Referring to FIG. 3, in an operation 330, the electronic device according to an embodiment may obtain a first response generated according to the prompt of the operation 320 from the trained model (e.g., the model 243 of FIG. 2). Although an embodiment of controlling the model using the prompt of the operation 320 is described, the embodiment is not limited thereto, and the electronic device may input information (e.g., information described in the disclosure and/or information self-evident from the disclosure) of another format different from the prompt to the model in order to obtain the first response of the operation 330. The electronic device may input the prompt to the trained model. The electronic device may obtain the first response of the operation 330 from the model to which the prompt is inputted. The first response may include information having a form (e.g., a natural language, an emoticon, an image, audio, and/or a video) instructed by the prompt. In a state of inputting a prompt including a request (e.g., a sentence based on the natural language) to generate a text message, the electronic device may obtain one or more sentences based on the natural language from the model. The first response may include not only a sentence, but also various types of character information including a word and/or a phrase.

Referring to FIG. 3, in an operation 340, the electronic device according to an embodiment may identify a keyword set by the prompt from the first response. In case that the electronic device generates a prompt requesting to generate a response having a form of the natural language, information obtained from the trained model may have the form of the natural language. In case that the electronic device generates a prompt requesting that the privacy information be replaced with the keyword, the information obtained from the trained model may include the keyword. The electronic device may search for the keyword in the first response obtained from the trained model. In case that the first response does not include the keyword, the electronic device may output the first response.

Referring to FIG. 3, in an operation 350, the electronic device according to an embodiment may obtain the privacy information corresponding to the keyword. The electronic device may obtain the privacy information of a category based on the keyword. The electronic device may obtain the privacy information associated with the keyword by searching database (e.g., the privacy DB 251 of FIG. 2) stored in a security area (e.g., the security area 250 of FIG. 2). The electronic device may obtain or identify the privacy information of the operation 350 by searching the database using the information associated with the prompt of the operation 320 as well as the keyword. The electronic device may search for the database by using not only the keyword, but also other texts different from the keyword in the first response obtained based on the operation 330.

Referring to FIG. 3, in an operation 360, the electronic device according to an embodiment may generate a second response by replacing the keyword of the first response with the privacy information obtained based on the operation 350. In case that the electronic device obtains the first response including texts based on the natural language, the electronic device may generate or obtain the second response including texts based on the natural language by changing the keyword of the first response to the privacy information of the operation 350.

Even when the first response does not include the keyword (or an indicator) included in the prompt of the operation 320, the electronic device according to an embodiment may identify a portion to be replaced with the privacy information in the first response, and may change the identified portion into the privacy information. For example, in case that information such as a schedule, a birthday, a date, an amount, a position, a contact, and/or account information is included from the first response, since the trained model is inaccessible to the privacy information, the information included in the first response has a high possibility of including an error. In the example, the electronic device may determine whether to change or replace the information, by comparing the information included in the first response with the privacy information. According to a preset type and/or a preset format, the electronic device may extract or obtain the information in the first response to be compared with the privacy information. In the example, the electronic device may change or replace the information included in the first response with the privacy information stored in the security area. The electronic device may change the information included in the first response based on whether the information included in the first response matches the privacy information in the security area.

An embodiment based on the natural language and/or texts has been described, but the embodiment is not limited thereto. For example, in case of identifying a user request to generate an image, the electronic device may obtain a first image using the trained model. The prompt inputted to the model to obtain the first image may include information (e.g., information in a form of a sentence) to display a portion corresponding to the privacy information (e.g., a face of a user of the electronic device, texts corresponding to personal information) with a marker (or a preset color). In the first image obtained from the trained model, the electronic device that detects the marker (or the preset color) may generate a second image by changing at least a portion of the first image using the privacy information (e.g., a photo of the face of the user). Even in case that a user request for generating a video and/or audio is identified, the electronic device may perform an operation similar to the operation of changing the first image to the second image.

Referring to FIG. 3, in an operation 370, the electronic device according to an embodiment may output the second response. For example, the electronic device may display or output the second response on the display (e.g., a messenger screen), such as the states 193 and 194 of FIG. 1. The electronic device displaying the second response may visually emphasize (e.g., an underline and/or adjustment of a font color) a word and/or a portion (e.g., numbers) associated with the privacy information in the second response.

The electronic device outputting the second response based on the operation 370 may further receive a request associated with the second response. For example, the electronic device may identify or receive a transmission request with respect to the second response. The electronic device that identifies the transmission request may transmit the second response to an external electronic device through communication circuitry.

Hereinafter, an operation of the electronic device generating the prompt of the operation 320 will be described with reference to FIG. 4.

FIG. 4 illustrates an operation of an electronic device for inputting a prompt to a trained model (e.g., the model 243 of FIG. 2) according to an embodiment of the disclosure. The electronic device 101 and/or the processor 210 of FIGS. 1 and 2 may perform an operation of FIG. 4. An operation of the electronic device described with reference to FIG. 4 may be associated with at least one (e.g., the operation 320) of the operations of FIG. 3.

Referring to FIG. 4, a state 191 of the electronic device 101 for displaying a messenger screen is illustrated. The state 191 of FIG. 4 may correspond to the state 191 of FIG. 1. The electronic device 101 may identify or receive a user request (e.g., the user request of the operation 310 of FIG. 3) to generate a response in a form of a text message using the trained model (e.g., the model 243 of FIG. 2) based on an input indicating to select a visual object 114.

The electronic device 101 that receives the user request may generate a prompt 410. The prompt 410 may indicate a task to be performed by a model, background information (e.g., a context) required to perform the task, input data that is a target for performing the task, a form (e.g., markdown, an extended marked-up language (xml), and/or JavaScript object notation (JSON)) of a result of performing the task, or any combination thereof.

Referring to FIG. 4, text messages exchanged between users (e.g., a user of the electronic device 101, and a counterpart of a chatting session) may be included in a portion 411 of the prompt 410 generated by the electronic device 101 as the background information to be inputted to the model. For example, history information may be stored in the portion 411. In case that text messages of a chatting session linked to a plurality of counterparts are identified, the electronic device 101 may (selectively) input text messages of a counterpart corresponding to the last received text message into the portion 411. In case that the text messages of the chatting session linked to the plurality of counterparts are identified, the electronic device 101 may display a UI for selecting at least one counterpart from the plurality of counterparts. In case that an input to select the at least one counterpart through the UI is received, the electronic device 101 may input text messages associated with the at least one counterpart selected by the input into the portion 411.

A portion 412 of the prompt 410 may include at least one sentence indicating a task to be performed by the trained model. Referring to the portion 412 of FIG. 4, the electronic device 101 may generate the prompt 410 including a sentence indicating to output (or infer) a text message that is composable from a perspective of a user of the electronic device 101. An embodiment is not limited thereto, and the electronic device 101 may add one or more sentences to the portion 412 of the prompt 410 for instructing a tone, a style, and/or a language of the text message to be generated from the trained model based on the text messages exchanged between the users. When generating the prompt 410, the electronic device 101 may display a UI (e.g., menu) for selecting the tone, the style, and/or the language on a display 110. An embodiment is not limited thereto, and the electronic device 101 may generate the prompt 410 including at least one word provided from the user.

Referring to the portion 412 of FIG. 4, the electronic device 101 may generate the prompt 410 including a sentence instructing to represent privacy information (e.g., personal information) as a keyword (e.g., a keyword including a preset character such as “@”). The keyword may indicate a type and/or a category of the privacy information to be included in a response. For example, the electronic device may generate the prompt 410 including the keyword so as not to include texts that does not match information (e.g., the privacy information) that is inaccessible by the trained model. The prompt 410 may include a sentence (e.g., “If you don't have any access to personal data, do use “@keyword” instead of using personal information and make a reply sentence.”) for replacing the unmatched texts with the keyword. The prompt 410 may include a plurality of keywords (e.g., a schedule, a birthday, a name, and/or a position) that may be included in the response. The portion 412 may further include information for restricting (e.g., the number of characters allowed by the software application) a length of the response outputted from the trained model.

Referring to a portion 413 of FIG. 4, the electronic device 101 may generate the prompt 410 indicating a format of the response to be outputted from the trained model. Based on a JSON format, the electronic device 101 may generate the prompt 410 including the portion 413 indicating to input a list of a keyword included in the response in a variable having a name of “keyword” and to input the response in a variable having a name of “answer”. An embodiment is not limited thereto. For example, the electronic device 101 may generate the prompt 410 for outputting the keyword included in the response together with the response.

Referring to FIG. 4, the electronic device 101 may obtain information 420 including a response 422 by inputting the prompt 410 to the trained model. The information 420 may include information 421 indicating a keyword included in the response 422 together with the response 422 in a form of a natural language. In the information 420, the response 422 may be set to be stored in the variable having the name of “answer,” and the information 421 indicating the keyword may be set to be stored in the variable having the name of “keyword”.

According to an embodiment, the electronic device 101 may identify the keyword instructed by the prompt 410 in the response 422 included in the information 420. One or more keywords may be included (exemplarily) in the prompt 410. The trained model may be trained to generate the response 422 using at least one of the keywords included in the prompt 410. For example, the prompt 410 may include a plurality of keywords (e.g., “@schedule (423),” “#account number,” and/or “! address”), which is a combination of a preset symbol (e.g., “@,” “#,” and/or “!”) and a word. An embodiment is not limited thereto, and the prompt 410 may include a natural language sentence including at least one keyword as an example with respect to the response 422. For example, the electronic device 101 may search for the keyword (or a word) included in the information 421 in the response 422. For example, the electronic device 101, which has obtained “I don't have another schedule after @schedule p.m.” as the response 422, and “schedule” as the information 421 indicating the keyword may search for “schedule” in the response 422. In the response 422, the electronic device 101 may search for a combination of the preset character (e.g., “@”) representing the keyword and the keyword as the privacy information and/or an identifier (or a delimiter) with respect to the keyword.

Referring to FIG. 4, the electronic device 101 that identifies the keyword in the response 422 may search DB (e.g., the privacy DB 251 of FIG. 2) of the electronic device 101 to insert privacy information into a portion of the response 422 where the keyword is positioned. For example, the electronic device 101 that identifies the keyword (“@schedule”) indicating a schedule may search for the privacy information to replace the keyword by searching DB of a security area. The electronic device 101 may obtain the privacy information by searching DB (e.g., the calendar DB 261 of FIG. 2) corresponding to the keyword. A condition for searching for the DB may be determined based on the portion 411.

For example, in case that there is no schedule after 19:00 by searching for the schedule, the electronic device 101 may replace the keyword with texts (e.g., “7 p.m.”) indicating a search result in the response 422. The texts in which the keyword is changed to the search result (e.g., “I don't have another schedule after 7 p.m.”) may be displayed on the display 110.

A state of searching for the schedule is illustrated, but an embodiment is not limited thereto. For example, in case that a keyword such as “birthday” is included, the electronic device 101 may replace the keyword included in the response 422 with a birthday, which is privacy information by searching the profile DB 263 of FIG. 2.

According to an embodiment, the electronic device 101 may display a text message, obtained by replacing the keyword in the response 422 with the privacy information, on the display 110. An embodiment is not limited thereto, and the electronic device 101 may display the response 422 before displaying the text message. The electronic device 101 may change or replace the keyword with the privacy information based on an input (e.g., a touch input for the keyword) associated with the keyword included in the response 422. Based on the input, the electronic device 101 may display a visual object (e.g., a pop-up-window and/or a drop-down list) capable of selecting the privacy information to be replaced with the keyword. In the visual object, the electronic device 101 may display at least one candidate text to be replaced with the keyword. The candidate text may be generated or inferred from the privacy information (or a usage pattern of the user and/or chatting history) using the trained model. In case that the candidate text is not obtained, the electronic device 101 may execute another software application (e.g., a calendar application with respect to an input associated with a keyword corresponding to a schedule) associated with the keyword based on the input associated with the keyword. The user of the electronic device 101 may (directly) verify information to be inputted to the keyword, by using the other software application. The electronic device 101 may obtain texts to be inputted to the keyword, through the other software application. For example, in case that the user selects an empty time in a state of executing the calendar application, the electronic device 101 may change or replace the keyword with the selected time.

In a state of displaying the response 422 of FIG. 4, the electronic device 101 may display a drop-down list including, as items, times (e.g., times indicated as a free time by the privacy DB) that may be included in the response 422 based on the input. Based on an input to select any one of the items in the drop-down list, the electronic device 101 may change at least a portion of the response 422 into texts indicating a time corresponding to the input. The electronic device 101 may determine the privacy information to be replaced with the keyword, by using the visual object. The visual object may include a list of the privacy information that may be inserted into a portion of the response 422 in which the keyword is displayed.

Although an embodiment in which the electronic device 101 inputs the privacy information with respect to the user of the electronic device 101 in the response 422 has been described, the embodiment is not limited thereto. For example, the electronic device 101 may replace or change the keyword in the response 422 with information with respect to another user (e.g., a counterpart of a chatting session) other than the user.

For example, in case that the electronic device 101 obtains a plurality of responses including the response 422, the electronic device 101 may perform an operation of searching for a keyword with respect to each of the plurality of responses. In case that a specific response does not include a keyword, the electronic device 101 may display the specific response, together with another response, on the display 110. The plurality of responses may be displayed in a form of a list on the display 110, such as the states 192, 193, and 194 of FIG. 1.

Hereinafter, an operation of the electronic device 101 that identifies a user request for executing the trained model through a UI different from the messenger screen will be described.

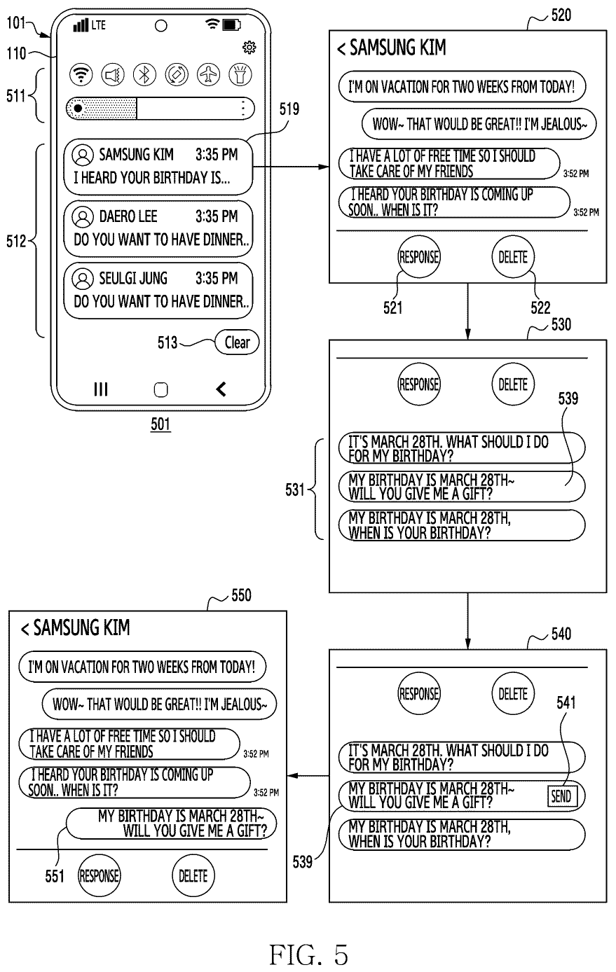

FIG. 5 illustrates a user interface (UI) displayed by an electronic device 101 that generates a response with respect to a user request according to an embodiment of the disclosure. Referring to FIG. 5, a state 501 of the electronic device 101 performing the operations of FIGS. 1 to 4 is illustrated.

Referring to the state 501 of FIG. 5, the electronic device 101 may display a panel (e.g., a notification panel) in which notification messages are accumulated on a display 110. The panel may be displayed based on a gesture (e.g., a swipe gesture performed along a vertical direction of the display 110 from a top of the display 110) performed on the display 110. The panel may display a portion 511 for adjusting a setting value (e.g., brightness of the display 110, a Wi-Fi connection state, a Bluetooth connection state, a reference direction of a screen, an airplane function, and/or flash light) of the electronic device 101, and a portion 512 in which the notification messages are accumulated. In the portion 512, visual objects representing a software application executed by the electronic device 101 and/or a push message transmitted to the electronic device 101 may be accumulated. In the portion 512, the electronic device 101 may display a visual object 513 (e.g., a button including preset texts such as “clear”) for removing the accumulated visual objects in the portion 512. The electronic device 101 that receives an input associated with the visual object 513 may delete or hide the visual objects included in the portion 512.

Referring to FIG. 5, the electronic device 101 that receives a text message (e.g., “I heard your birthday is coming up soon. When is it?”) based on a SMS (or another messenger service) may display a visual object 519 representing the text message in the panel illustrated in FIG. 5. In response to an input indicating to select the visual object 519, the electronic device 101 may display a pop-up window 520. For example, the pop-up-window 520 may be displayed superimposed on the panel illustrated in the state 501. For example, the pop-up-window 520 may be displayed in the portion 512 on a position where the visual object 519 was displayed. An embodiment is not limited thereto, and the electronic device 101 that identifies the input associated with the visual object 519 may switch to the state 191 of FIG. 1.

The electronic device 101 displaying the pop-up window 520 may display text messages exchanged through a chatting session associated with the text message corresponding to the visual object 519 in the pop-up window 520. The electronic device 101 may display, in the pop-up-window 520, a visual object 521 for generating a response based on a trained model (e.g., the model 243 of FIG. 2) and a visual object 522 for ceasing display of the visual object 519. In response to an input to select the visual object 522, the electronic device 101 may cease displaying the pop-up window 520. In response to an input indicating selection of the visual object 522, the electronic device 101 may remove or hide the visual object 519 in the portion 512.

The electronic device 101 that receives an input to select the visual object 521 through the pop-up window 520 may perform an operation described with reference to FIGS. 1 to 4. For example, the electronic device 101 may generate a prompt to be inputted to the trained model by using one or more text messages stored in the chatting session. The prompt may include a request to display privacy information as an identifier, a word, and/or an indicator, such as a keyword. The electronic device 101 may execute the trained model using the prompt. Since the prompt includes the one or more text messages, the one or more text messages may be inputted to the trained model.

The electronic device 101 may obtain at least one response message to be transmitted to an external electronic device from the trained model, by executing the trained model. Based on determination that a preset identifier is included in the at least one response message, the electronic device 101 may replace the preset identifier included in the at least one response message with the privacy information (e.g., the information stored in the privacy DB 251 of FIG. 2) stored in the electronic device 101. The electronic device 101 may display the at least one response message in which the preset identifier is replaced with the privacy information in a pop-up window 530 displayed on the display 110. For example, at least one response message may be displayed on a portion 531 of the pop-up window 530. An embodiment in which response messages including the privacy information are displayed through the portion 531 is illustrated, but the embodiment is not limited thereto. For example, the electronic device 101 may display a response message (e.g., “Why? Are you going to give me a gift?”, “Guess?”, “Don't you know that either?”, “I don't know either”, “I'll let you know later”, and/or “It's hard to tell you”) that does not (at all) include the privacy information in the portion 531 together with a response message that includes the privacy information.

Referring to FIG. 5, an embodiment in which response messages in a single language (e.g., a language preset by a user) are displayed through the portion 531 is illustrated, but the embodiment is not limited thereto. For example, the electronic device 101 may display response messages in different languages through the portion 531. For example, a language of a response message may include not only a (default) language set by the user of the electronic device 101, but also a language of the text message(s) exchanged through the chatting session. The electronic device 101 may identify or verify the language of the text message(s) exchanged through the chatting session using an artificial intelligence model. The electronic device 101 that identifies the language may add a natural language sentence indicating to generate a response based on the identified language to a prompt (e.g., the prompt 410 of FIG. 4). According to an embodiment, the electronic device 101 may generate and provide one response (e.g., a natural language sentence) in a plurality of languages. For example, the response generated from the electronic device 101 may include a first natural language sentence of a first language and a second natural language sentence of a second language.

While displaying the pop-up window 530, the electronic device 101 may receive an input to select any one of response messages. For example, the electronic device 101 may identify or receive an input to select a visual object 539 corresponding to a specific response message (e.g., “My birthday is March 28th˜Will you give me a gift?”). The electronic device 101 that identifies the input may display a visual object 541 for transmitting the response message corresponding to the visual object 539 on the visual object 539, such as a pop-up window 540. In response to an input indicating selection of the visual object 541, the electronic device 101 may transmit the response message to an external electronic device through the chatting session. The electronic device 101 may display a pop-up window 550 including a visual object 551 representing the response message in response to the input.

An operation of the electronic device 101 based on the text messages based on a birthday has been described, but an embodiment is not limited thereto. For example, the electronic device 101 that identifies a plurality of topics from the text messages exchanged through the chatting session may identify whether to generate a response message based on which topic among the plurality of topics. For example, the electronic device 101 may display a UI for selecting any one of the plurality of topics identified through the chatting session before controlling the trained model in response to an input indicating selection of the visual object 521. The UI may be displayed by the electronic device 101 to inform that the plurality of topics have been identified. Based on the topic selected through the UI, the electronic device 101 may generate a prompt (e.g., a prompt indicating to generate a response based on the selected topic) to be inputted to the trained model. For example, the electronic device 101 that identifies topics with respect to each of a meeting place and a meeting time through the chatting session may display a UI to verify whether to generate a response based on which topic among the meeting place and the meeting time. Based on the topic selected through the UI, the electronic device 101 may generate or display one or more response messages.

The electronic device 101 may identify one or more topics from the text messages exchanged through the chatting session by executing the artificial intelligence model (e.g., the model 243 of FIG. 2). In case of identifying the plurality of topics from the text messages exchanged through the chatting session, the electronic device 101 may obtain or generate a plurality of response messages corresponding to each of the plurality of topics using the trained model. The electronic device 101 may display a list including the plurality of obtained response messages. An embodiment is not limited thereto, and the electronic device 101 may obtain a response message based on any one topic among the plurality of topics. The electronic device 101 may display a topic corresponding to the response message together with the obtained response message. In response to a user input to select a topic different from the displayed topic, the electronic device 101 may generate or display at least one response message based on the topic selected by the user input.

An operation of the electronic device 101 based on a chatting session of performing a one-on-one chat with one counterpart has been described, but an embodiment is not limited thereto. For example, in the chatting session linked to a plurality of counterparts, the electronic device 101 may generate a prompt using a counterpart corresponding to a last received text message and a chat history with the counterpart. When providing response messages generated using the prompt, the electronic device 101 may receive an input (e.g., a long-press gesture with respect to a text message of another counterpart) for generating a response message to the other counterpart. Based on the input, the electronic device 101 may generate a prompt based on a chat history of the other counterpart, and obtain one or more response messages from a model to which the prompt is inputted. For example, the prompt may (selectively) include text messages of the counterpart and the user of the electronic device 101 among text messages accumulated in the chatting session. Based on the number of counterparts included in the chatting session, the electronic device 101 may transmit a prompt to any one model among a model in the electronic device 101 or a model in an external electronic device (e.g., a server), or may request a response message. For example, the electronic device 101 may generate one or more response messages using the model in the electronic device 101 with respect to the chatting session in which one-on-one chat is performed with one counterpart. For example, the electronic device 101 may request the server to transmit one or more response messages, with respect to the chatting session linked to the plurality of counterparts.

An embodiment is not limited thereto, and the electronic device 101 may generate a prompt indicating to generate response messages corresponding to each of the plurality of counterparts included in the chatting session. An embodiment is not limited thereto, and the electronic device 101 may display a UI for checking whether to generate a text message to be transmitted to which counterpart among the plurality of counterparts included in the chatting session. The electronic device 101 that receives an input to select a specific counterpart through the UI may generate a prompt instructing to generate a chat history between the counterpart and the user of the electronic device 101, and a text message to be transmitted to the counterpart. For example, the electronic device 101 that detects the plurality of counterparts, the plurality of topics, and/or a plurality of questions through the chatting session may generate a prompt to be inputted to the trained model by selecting a counterpart, a topic, and/or a question. In the example, the electronic device 101 that detects the plurality of counterparts, the plurality of topics, and/or the plurality of questions may transmit the prompt to the server to request the server to generate a response message.

An operation of displaying a simplified UI, such as the pop-up window 520, is not limited to an operation described with reference to FIG. 5. For example, the simplified UI such as the pop-up window 520 of FIG. 5 may be displayed on a display of a watch (e.g., the watch 294 of FIG. 2). For example, a foldable electronic device (e.g., the foldable-type smartphone 291-2 of FIG. 2) may include a flexible display having a first size and a cover display having a second size smaller than the first size. For example, the foldable electronic device may display the simplified UI, such as the pop-up window 520, on the cover display, and may display the UI illustrated with reference to FIG. 1 on the flexible display. For example, the foldable electronic device may display a response message generated using the trained model, such as the pop-up window 530, in a state in which the cover display is active (e.g., in a folded state in which the flexible display is not visible).

FIG. 6 illustrates a UI of an electronic device 101 displaying a response generated using a trained model (e.g., the model 243 of FIG. 2) according to an embodiment of the disclosure.

Referring to FIG. 6, a state 192 of the electronic device 101 performing the operations of FIGS. 1 to 5 is illustrated. The state 192 of FIG. 6 may correspond to the state 192 of FIG. 1. For example, the electronic device 101 may identify a user request to generate a response message using the trained model. In response to the user request, the electronic device 101 may obtain, from the trained model, an output message in which a portion to which privacy information is to be inputted is replaced with a keyword. The electronic device 101 may generate a candidate response message to be displayed on a portion 121 by replacing the keyword with the privacy information in the output message. As in the state 192 of FIG. 6, in case that a plurality of output messages are obtained, the electronic device 101 may generate or display a plurality of candidate response messages by replacing a keyword of each of the plurality of output messages with the privacy information.

Referring to FIG. 6, the electronic device 101 may display visual objects corresponding to each of the candidate response messages. The electronic device 101 may receive an input to transmit or edit the candidate response message through the visual object. For example, in the candidate response message included in the visual object, the electronic device 101 may display a pop-up-window 620 associated with the privacy information, such as a state 602, based on an input (e.g., a tap gesture) with respect to a portion 610 (e.g., “7 p.m.”) in which the privacy information is inputted. The input for displaying the pop-up window 620 may be performed by a user to edit the privacy information included in the candidate response message. In order to guide that the input with respect to the portion 610 may be received, the electronic device 101 may visually emphasize the portion 610 with respect to a remaining portion of the candidate response message.

Referring to FIG. 6, in the state 602, the electronic device 101 may display the pop-up window 620 by executing a software application (e.g., a calendar application) associated with the privacy information. Since the portion 610 includes texts (e.g., “7 p.m.”) associated with a schedule, the electronic device 101 may display the pop-up window 620 provided from the calendar application. The user of the electronic device 101 may determine whether texts inputted to the portion 610 is correct, through the pop-up window 620.

Referring back to the state 192 of FIG. 6, the electronic device 101 may receive an input (e.g., a request for editing the candidate response message and/or the privacy information included in the candidate response message) to edit the candidate response message through a visual object 123 indicating the candidate response message. For example, the electronic device 101 that detects a long-touch gesture (e.g., a finger-based gesture contacted on the visual object 123 during a period exceeding approximately 1.5 seconds) on the visual object 123 may switch to a state 603. In the state 603, the electronic device 101 may display the candidate response message on a text box 631 of a portion 112 of a display 110. In the state 603, the electronic device 101 may display a virtual keyboard on a portion 113. The electronic device 101 may receive the input to edit the candidate response message included in the text box 631, through the virtual keyboard.

In the state 603 of FIG. 6, the electronic device 101 may display a visual object 632 for transmitting texts (e.g., the candidate response message) displayed through the text box 631 to a counterpart of a chatting session in the portion 112 of the display 110. The electronic device 101 that receives an input (e.g., a tap gesture with respect to the visual object 632) associated with the visual object 632 may transmit the texts displayed on the text box 631 to the counterpart (or an external electronic device of the counterpart) through the chatting session.

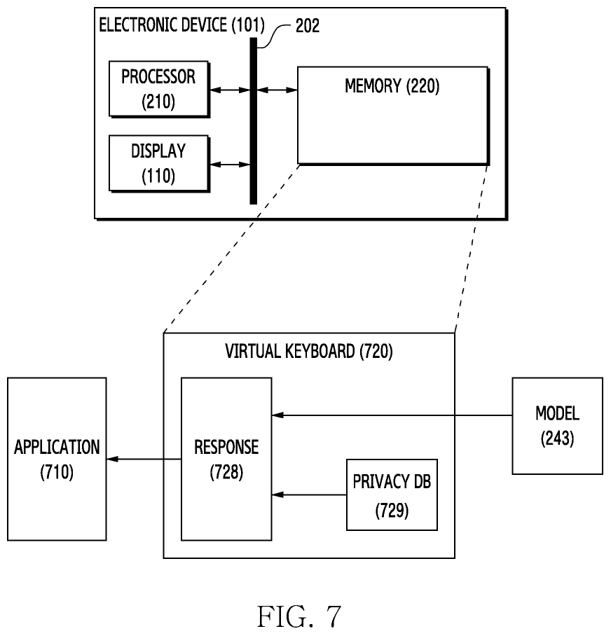

As described above with reference to FIGS. 1 to 6, the response generated based on the trained model may be displayed through the portion 113 of the display 110 on which the virtual keyboard is displayed. For example, a program (e.g., the response generator 242 of FIG. 2) that controls the trained model may be included as a portion of a program to provide the virtual keyboard. Hereinafter, an operation of the electronic device 101 that controls the trained model using the program to provide the virtual keyboard will be described with reference to FIG. 7.

FIG. 7 schematically illustrates a block diagram with respect to programs executed by an electronic device 101 according to an embodiment of the disclosure. A description overlapping the descriptions of FIGS. 1 to 6 among descriptions of FIG. 7 is omitted for convenience of description.

Referring to FIG. 7, a virtual keyboard 720, which is a software application for displaying the virtual keyboard displayed through the portion 113 of FIGS. 1, 4, and/or 6, may be executed by a processor 210. The processor 210 may display a virtual keyboard including the visual object 114 of FIG. 1 and/or FIG. 4 on a display (e.g., the display 110 of FIGS. 1 to 6) by executing the virtual keyboard 720. For example, the processor 210 may identify or detect a user request (e.g., the request of the operation 310 of FIG. 3) for generating a text response based on a model 243 through the virtual keyboard 720.

The processor 210 that identifies the user request through the virtual keyboard 720 may generate a prompt based on the operation 320 of FIG. 3. The processor 210 may input the generated prompt to the model 243 and receive a first response from the model 243. In the first response, the processor 210 that detects a preset keyword (or a preset identifier) set by the prompt may replace the preset keyword with privacy information using privacy DB 729. The privacy DB 729 may correspond to the privacy DB 251 of FIG. 2 and may be accessed exclusively by the virtual keyboard 720. A response 728 generated using the model 243 and the privacy DB 729 may be displayed on a portion (e.g., the portion 113 of FIG. 1 and/or FIG. 6) of the display 110 on which the virtual keyboard 720 is being displayed. The processor 210 may execute an application 710 (e.g., the messenger application described with reference to FIG. 1 and/or FIG. 6) by using the response 728.

As described above, according to an embodiment, the electronic device 101 may logically separate the trained model 243 and the privacy DB 729. For example, the model 243 may be restricted from accessing the privacy DB 729. The electronic device 101 may cause the model 243 to output a natural language that represents a portion in which information of the privacy DB 729 is to be inputted as a reserved word (e.g., a keyword, an identifier, a marker, and/or an indicator), by using the prompt inputted to the model 243. In the natural language, the electronic device 101 may obtain a natural language to be outputted to a user of the electronic device 101 by replacing the reserved word with the privacy information.

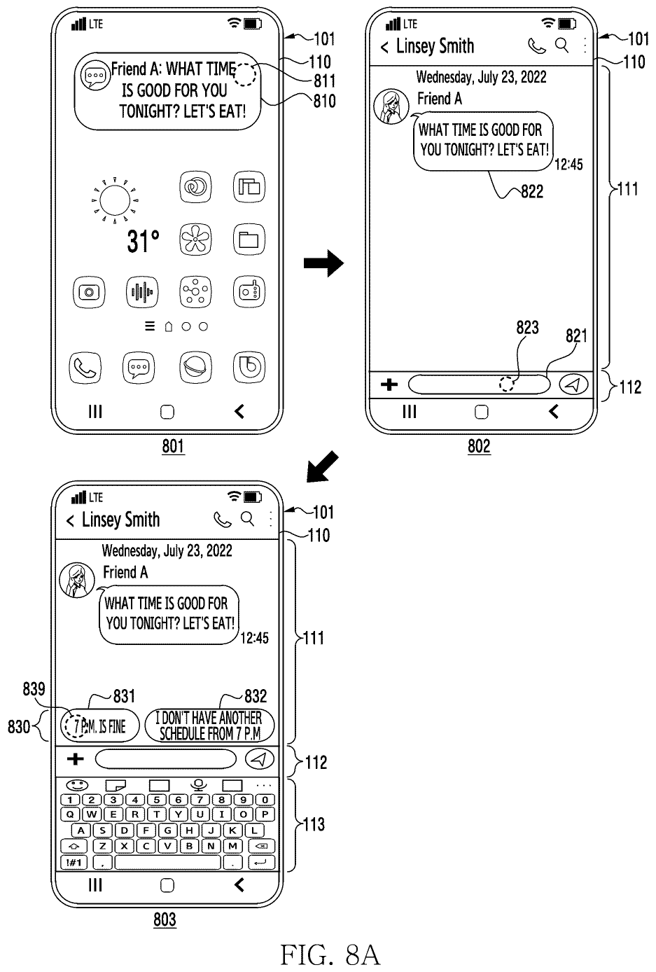

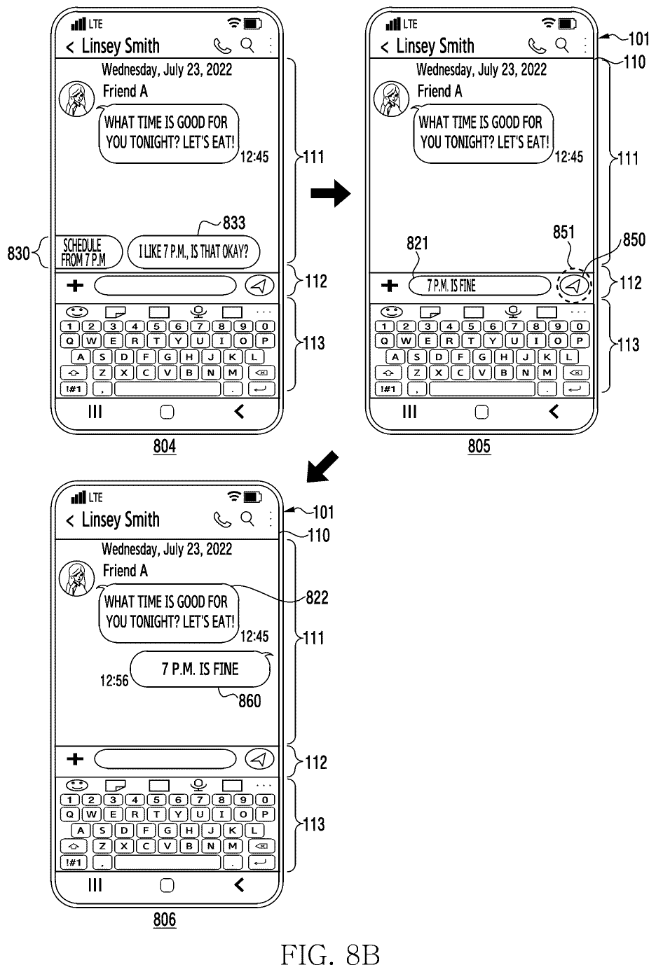

FIGS. 8A and 8B illustrate a UI displayed by an electronic device 101 according to various embodiments of the disclosure.

Referring to FIGS. 8A and 8B, states 801, 802, 803, 804, 805, and 806 of the electronic device 101 including a display 110 are illustrated.

In the state 801 of FIG. 8A, the electronic device 101 may display a home screen (or a launcher screen) on the display 110. In the state 801, the electronic device 101 that receives a text message may display a pop-up object 810 including the text message on the display 110. The electronic device 101 that receives an input with respect to a point 811 in the display 110 in which the pop-up object 810 is displayed may switch from the state 801 to the state 802. The input may include a tap gesture on the point 811.

In the state 802 of FIG. 8A, the electronic device 101 may execute a messenger application. In the state 802, the electronic device 101 may display a messenger screen provided from the messenger application on the display 110. The messenger screen may include a portion 111 for displaying text messages exchanged through a chatting session (e.g., a chatting session associated with the text message included in the pop-up object 810) and a portion 112 for receiving a text message to be transmitted through the chatting session. The electronic device 101 may display a visual object 822 in a form of a bubble, including the text message included in the pop-up object 810 through the portion 111.

In the state 802 of FIG. 8A, the electronic device 101 that receives an input with respect to a point 823 in the display 110 in which a visual object 821 (e.g., a visual object, referred to as a text box, on which one or more characters inputted by a user are displayed) included in the portion 112 is displayed may switch to the state 803.

In the state 803 of FIG. 8A, the electronic device 101 may display a virtual keyboard in the portion 113 of the display 110. The electronic device 101 may display response messages obtained from a model trained based on the operation described with reference to FIGS. 1 to 7 in a portion 830 of the display 110. Referring to the state 803 of FIG. 8A and the state 804 of FIG. 8B, visual objects 831, 832, and 833 disposed in the portion 830 may each correspond to the response messages obtained from the trained model. The visual objects 831, 832, and 833 may be scrolled in the portion 830, based on a drag gesture (e.g., a drag gesture in a horizontal direction) with respect to the portion 830 of the display 110.

Referring to the state 803 of FIG. 8A and the state 804 of FIG. 8B, the visual objects 831, 832, and 833 disposed in the portion 830 may each include text messages generated based on the text message (e.g., a text message included in the visual object 822 including a natural language sentence asking for an evening schedule) included in the chatting session. The text messages included in each of the visual objects 831, 832, and 833 may be obtained from the trained model and may be generated by replacing a preset keyword with privacy information in responses including the preset keyword indicating a schedule.

In the state 803 of FIG. 8A and/or the state 804 of FIG. 8B, the electronic device 101 may receive an input to select any one of the visual objects 831, 832, and 833 positioned in the portion 830. For example, in the state 803 of FIG. 8A, the electronic device 101 that receives an input with respect to a point 839 in the display 110 in which the visual object 831 is displayed may switch to the state 805 of FIG. 8B.

In the state 805 of FIG. 8B, the electronic device 101 may display, in the visual object 821, texts that was included in the visual object 831. In the state 805 in which the texts are displayed in the visual object 821, the electronic device 101 may receive an input to edit the texts included in the visual object 821 through the virtual keyboard displayed through the portion 113. In the state 805 of FIG. 8B, the electronic device 101 that receives an input (e.g., an input with respect to a point 851 in the display 110 in which a send button 850 is displayed) with respect to the send button 850 included in the portion 112 may switch to the state 806 of FIG. 8B. The electronic device 101 that receives the input may execute a function for transmitting the texts included in the visual object 821 to a counterpart (or an external electronic device of the counterpart) through the chatting session.

In the state 806 of FIG. 8B, the electronic device 101 may transmit a text message (e.g., “7 p.m. is fine”) generated by the trained model. The electronic device 101 may display a visual object 860 in a form of a bubble, including the text message, in the portion 111. In the portion 111, the visual object 860 may be positioned under the visual object 822 corresponding to a last received text message.

In the disclosure, an operation of the electronic device 101 generating texts to be transmitted to the counterpart based on a messenger service (or the messenger application) has been described, but an embodiment is not limited thereto. For example, when generating a comment (or a post) to be added to a community (an internet bulletin board), the electronic device 101 may perform the operation of the disclosure. For example, the electronic device 101 that receives an input to generate a product review to be registered in the community may generate or output at least one candidate text that may be used as the product review by performing the operation of the disclosure. For example, the electronic device 101 that receives an input to generate a subtitle with respect to a specific video (e.g., a video stored in the electronic device 101) may generate or obtain texts to be coupled with the video by performing the operation of the disclosure.

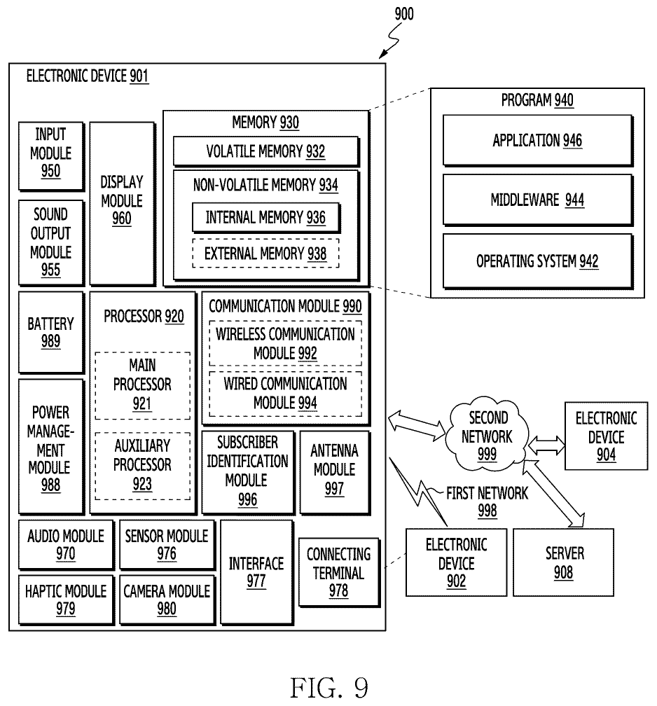

Hereinafter, a hardware configuration of the electronic device 101 of FIGS. 1 to 7 will be described with reference to FIG. 9.

FIG. 9 is a block diagram illustrating an electronic device 901 in a network environment 900 according to an embodiment of the disclosure. Referring to FIG. 9, the electronic device 901 in the network environment 900 may communicate with an electronic device 902 via a first network 998 (e.g., a short-range wireless communication network), or at least one of an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module (SIM) 996, or an antenna module 997. In some embodiments, at least one of the components (e.g., the connecting terminal 978) may be omitted from the electronic device 901, or one or more other components may be added in the electronic device 901. In some embodiments, some of the components (e.g., the sensor module 976, the camera module 980, or the antenna module 997) may be implemented as a single component (e.g., the display module 960).

The processor 920 may execute, for example, software (e.g., a program 940) to control at least one other component (e.g., a hardware or software component) of the electronic device 901 coupled with the processor 920, and may perform various data processing or computation. According to an embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the electronic device 901, from the outside (e.g., a user) of the electronic device 901. The input module 950 may include, for example, a microphone, a mouse, a keyboard, a key (e.g., a button), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to an embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the millimeter wave (mmWave) band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20 Gbps or more) for implementing eMBB, loss coverage (e.g., 964 dB or less) for implementing mMTC, or U-plane latency (e.g., 0.5 ms or less for each of downlink (DL) and uplink (UL), or a round trip of 9 ms or less) for implementing URLLC.

The antenna module 997 may transmit or receive a signal or power to or from the outside (e.g., the external electronic device) of the electronic device 901. According to an embodiment, the antenna module 997 may include an antenna including a radiating element composed of a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 or 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In another embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

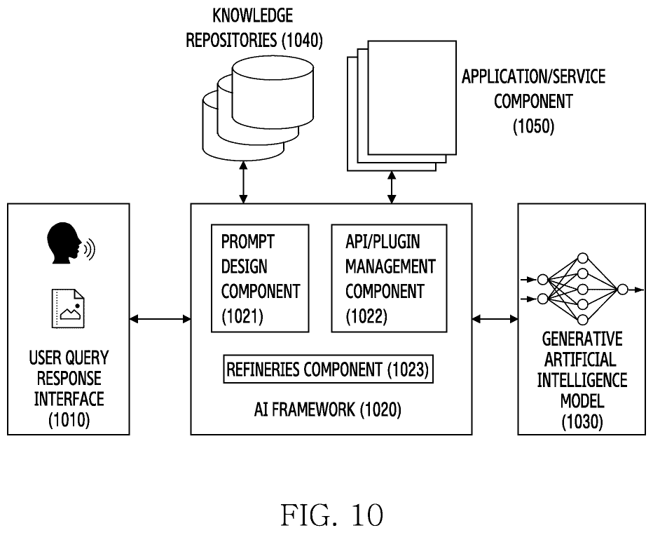

FIG. 10 is a schematic diagram of an AI system according to an embodiment of the disclosure.

Referring to FIG. 10, an AI system 1000 may include an input/output interface 1010, an AI framework 1020, a generative AI model 1030, and/or a knowledge storage (e.g., knowledge repositories 1040). The generative AI model 1030 of FIG. 10 may correspond to the model 243 of FIG. 2.

The input/output interface 1010 may receive an input. The input may include data obtained or generated by a user input and/or an electronic device (e.g., the electronic device 101 or the electronic device 901 described above). The data may include an image, a video, and/or sensor data (e.g., illuminance data around the electronic device obtained from a sensor or a sensor hub (e.g., an auxiliary processor 923), posture data (or orientation data) of the electronic device, a temperature (e.g., a temperature of a display 110, or a temperature of at least one processor 210) inside the electronic device, size information of a display area of the display 110, and/or an image obtained through an image sensor (e.g., included in a camera module 980) of the electronic device) generated by at least one processor (e.g., the at least one processor 210 or a processor 920) of the electronic device. The user input may include a natural language, touch data obtained through touch circuitry (e.g., used to identify an input from a finger and/or a stylus) included in a display module 960, an image displayed (and/or to be displayed) on the display module 960, and/or a video. As a non-limiting example, the user input may be received by the input/output interface 1010 together with context information. The context information may be described as additional information obtained in association with the user input. The context information may be associated with a state (e.g., including a state of the electronic device and/or a state (e.g., a user state) around the electronic device) when the user input is received. For example, the context information may include information with respect to one or more software applications executed in the electronic device when the user input is received. For example, the context information may include information with respect to a position (or a position of a user of the electronic device) of the electronic device when the user input is received. For example, the user input may be integrated with the context information. For example, a user input in which the context information is integrated as the input may be received by the input/output interface 1010.

The input/output interface 1010 may transmit (or provide) an output. The output may include a result (or result information) generated or obtained by the AI system 1000, based at least in part on the input. The format of the output may vary. For example, the output may include a natural language. For example, the output may include content (e.g., including media content and/or multimedia content). For example, the output may include an action associated with the user of the electronic device. For example, the output may have a format according to a user setting of the electronic device.

The input/output interface 1010 may be described as a user query/response interface 1010.

The AI framework 1020 may obtain information (or data) with respect to the input from the input/output interface 1010, and may be used to control one or more components associated with the AI system 1000 using the obtained information.

For example, a prompt design component 1021 in the AI framework 1020 may generate or obtain a prompt for the generative AI model 1030 (e.g., including a large language model (LLM) or a large multimodal model (LMM)) using the obtained information. For example, the prompt design component 1021 may be described as an AI component using a learning algorithm and/or a neural network to provide an enhanced prompt over time. For example, using the obtained information, the prompt design component 1021 may generate or obtain the prompt by accessing a knowledge component (e.g., the knowledge storage 1040) including user preference data, a prompt library, and/or a prompt example. The generated prompt may be provided to the generative AI model 1030 (e.g., including the LLM or the LMM).

For example, an API/plugin management component 1022 in the AI framework 1020 may be used to support communication for additional information requested (or caused) in association with the prompt provided (or to be provided) to the generative AI model 1030. For example, the API/plugin management component 1022 may be used to generate or establish a channel for communication with various data sources (e.g., the knowledge storage 1040). For example, the API/plugin management component 1022 may support access to at least a portion of the data sources. For example, the API/plugin management component 1022 may be used to request another component (e.g., an application/service component 1050) that performs feedback (or a response) according to the prompt. As a non-limiting example, information obtained (or generated) through the API/plugin management component 1022 may be provided to the prompt design component 1021 for generation of the prompt. As a non-limiting example, the information obtained (or generated) through the API/plugin management component 1022 may be provided to the generative AI model 1030.

For example, an improvement component (e.g., refineries component 1023) in the AI framework 1020 may at least partially tune (or adjust) (or change) a result (e.g., content) obtained (or outputted) from the generative AI model 1030. For example, the improvement component (e.g., refineries component 1023) may determine or verify whether the content obtained from the generative AI model 1030 is associated with the input. For example, the improvement component (e.g., refineries component 1023) may determine or verify whether the content obtained from the generative AI model 1030 includes biased content. For example, the improvement component (e.g., refineries component 1023) may determine or verify whether the content obtained from the generative AI model 1030 includes harmful content. For example, the improvement component (e.g., refineries component 1023) may support or assist in performing additional processing to improve the content obtained from the generative AI model 1030. For example, the improvement component (e.g., refineries component 1023) may support providing a hint to the user to improve the content.

The generative AI model 1030 may be described as an artificial intelligence neural network that generates feedback in response to the prompt. For example, the feedback is associated with the prompt, but may further include additional data and/or information relative to the prompt. For example, the feedback may include new content relative to the prompt. For example, the generative AI model 1030 may include a model that generates an image and/or a model that generates a language. For example, the model that generates the image may include a generative adversarial network (GAN) and/or a variational auto encoder (VAE). For example, the model that generates the image may include a diffusion-based generative model (e.g., a transformer VAE). For example, the model that generates the language may include CHAT-GPT 3 and/or CHAT-GPT 4. For example, the generative AI model 1030 may include the LMM that generates the feedback by recognizing a character, an image, and/or a voice.

As a non-limiting example, the AI framework 1020 and/or the generative AI model 1030 may be included in an AI module (e.g., including processing circuitry) in the electronic device. For example, the AI module may be operatively coupled with at least one processor (e.g., the at least one processor 210 or the processor 920) of the electronic device. For example, the AI module may be operatively coupled with display driving circuitry (e.g., display driving circuitry) of the electronic device. For example, the AI module may be operatively coupled with the sensor hub of the electronic device for one or more sensors in the electronic device.

In an embodiment, a method of blocking access to privacy information by an automation agent such as an artificial intelligence model may be required. In an embodiment, a method of obtaining information including the privacy information may be required using a trained model that is inaccessible to the privacy information. In an embodiment, a method of adding the privacy information to output information obtained from the trained model, which is inaccessible to the privacy information, may be required based on post-processing. As described above, according to an embodiment, an electronic device (e.g., the electronic device 101 of FIG. 1 and/or the electronic device 901 of FIG. 9) may comprise memory (e.g., the memory 220 of FIG. 2) comprising one or more storage media and storing instructions, and at least one processor (e.g., the processor 210 of FIG. 2) including processing circuitry. The instructions, when executed by the at least one processor individually or collectively, may cause the electronic device to identify an event for generating a response. The instructions, when executed by the at least one processor individually or collectively, may cause the electronic device to, based on identifying the event, generate a prompt (e.g., the prompt 410 of FIG. 4) to replace information associated with a second storage area (e.g., the security area 250 of FIG. 2) different from a first storage area (e.g., the general area 240 of FIG. 2) of the memory, with a keyword. The instructions, when executed by the at least one processor individually or collectively, may cause the electronic device to provide the prompt to a trained model in the electronic device configured to be able to access, among the first storage area (e.g., the general area 240 of FIG. 2) or the second storage area of the memory, the first storage area. The instructions, when executed by the at least one processor individually or collectively, may cause the electronic device to obtain a first response generated according to the prompt, from the trained model. The instructions, when executed by the at least one processor individually or collectively, may cause the electronic device to generate a second response by replacing the keyword included in the first response with privacy information in the second storage area (e.g., the security area 250 of FIG. 2) of the memory. According to an embodiment, the electronic device may block access to the privacy information by the automation agent such as the artificial intelligence model. According to an embodiment, the electronic device may obtain the information including the privacy information using the trained model that is inaccessible to the privacy information. According to an embodiment, the electronic device may add the privacy information to the output information obtained from the trained model, which is inaccessible to the privacy information, based on post-processing.

For example, the electronic device may comprise a display (e.g., the display 110 of FIG. 2). The instructions, when executed by the at least one processor individually or collectively, may cause the electronic device to identify a user request through a messenger screen displayed on the display. The instructions, when executed by the at least one processor individually or collectively, may cause the electronic device to generate the prompt including a plurality of text messages able to be displayed in the messenger screen.

For example, the electronic device may comprise communication circuitry. The instructions, when executed by the at least one processor individually or collectively, may cause the electronic device to display, on the display, the second response. The instructions, when executed by the at least one processor individually or collectively, may cause the electronic device to, based on identifying a transmission request with respect to the second response, transmit the second response to an external electronic device through the communication circuitry.

For example, the instructions, when executed by the at least one processor individually or collectively, may cause the electronic device to identify, through the second response displayed on the display, an editing request with respect to the privacy information that is included in the second response. The instructions, when executed by the at least one processor individually or collectively, may cause the electronic device to, based on identifying the editing request, display a pop-up window of a software application associated with the privacy information superimposed on the messenger screen on the display.

For example, the instructions, when executed by the at least one processor individually or collectively, may cause the electronic device to generate the second response by searching for the privacy information included in at least one of calendar database, messenger database, contact database, or wallet database, which are associated with a user of the electronic device.

For example, the instructions, when executed by the at least one processor individually or collectively, may cause the electronic device to generate the prompt including the keyword such that the first response does not include texts different from information stored in the calendar database.

For example, the instructions, when executed by the at least one processor individually or collectively, may cause the electronic device to generate the prompt to output a list of the keyword included in the first response, together with the first response.

As described above, according to an embodiment, an electronic device may comprise memory comprising one or more storage media and storing instructions, and at least one processor including processing circuitry. The instructions, when executed by the at least one processor individually or collectively, may cause the electronic device to provide a chatting session in which at least one message exchanged between a first user of the electronic device and a second user of another electronic device is displayed. The instructions, when executed by the at least one processor individually or collectively, may cause the electronic device to, in response to a first request, obtain a first message to be transmitted to the another electronic device from a first model, by inputting the at least one message to the first model set to generate character strings based on the provided input. The instructions, when executed by the at least one processor individually or collectively, may cause the electronic device to, at least based on determination that the first message includes a preset identifier, display a second message in which the preset identifier is replaced with privacy information stored in the electronic device. The instructions, when executed by the at least one processor individually or collectively, may cause the electronic device to, in response to a second request, transmit, to the another electronic device, the second message through the chatting session.

For example, the preset identifier may correspond to one of a plurality of identifiers which are provided for the first model together with the at least one message.

For example, the preset identifier may include a combination of texts which are to be changed with respect to the privacy information, and a symbol which is not to be changed with respect to the privacy information.

For example, the first message may include at least one sentence including a portion corresponding to the preset identifier. The instructions, when executed by the at least one processor individually or collectively, may cause the electronic device to identify a type of the privacy information using the preset identifier. The instructions, when executed by the at least one processor individually or collectively, may cause the electronic device to identify the privacy information using a remaining portion of the at least one sentence and the identified type.

For example, the instructions, when executed by the at least one processor individually or collectively, may cause the electronic device to display the first message before displaying the second message. The instructions, when executed by the at least one processor individually or collectively, may cause the electronic device to, based on an input with respect to the preset identifier included in the first message, change the preset identifier to the privacy information.

For example, the instructions, when executed by the at least one processor individually or collectively, may cause the electronic device to, in response to the input, display a visual object such that the first user is able to select the privacy information corresponding to the preset identifier of the first message.

For example, the privacy information may include information with respect to the second user.

For example, the instructions, when executed by the at least one processor individually or collectively, may cause the electronic device to, based on the at least one message being longer than a preset length, generate a summarized message to be inputted to the first model, by summarizing the at least one message using a second model different from the first model.

For example, the instructions, when executed by the at least one processor individually or collectively, may cause the electronic device to obtain a third message not including the preset identifier. The instructions, when executed by the at least one processor individually or collectively, may cause the electronic device to display the third message together with the second message.

For example, the second request may include an input to select the second message among the second message and the third message.

As described above, in an embodiment, a method of an electronic device may be provided. The method may comprise providing a chatting session in which at least one message exchanged between a first user of the electronic device and a second user of another electronic device is displayed. The method may comprise, in response to a first request, obtaining a first message to be transmitted to the another electronic device from a first model, by inputting the at least one message to the first model set to generate character strings based on the provided input. The method may comprise, at least based on determination that the first message includes a preset identifier, displaying a second message in which the preset identifier is replaced with privacy information stored in the electronic device. The method may comprise, in response to a second request, transmitting to the another electronic device the second message through the chatting session.

For example, the preset identifier may correspond to one of a plurality of identifiers which are provided for the first model together with the at least one message.

For example, the preset identifier may include a combination of texts which are to be changed with respect to the privacy information, and a symbol which is not to be changed with respect to the privacy information.

For example, the first message may include at least one sentence including a portion corresponding to the preset identifier. The method may comprise identifying a type of the privacy information using the preset identifier. The method may comprise identifying the privacy information using a remaining portion of the at least one sentence and the identified type.

For example, the method may comprise displaying the first message before displaying the second message. The displaying the first message may comprise, based on an input with respect to the preset identifier, changing the preset identifier to the privacy information.

For example, the displaying the first message may comprise, in response to the input, displaying a visual object such that the first user is able to select the privacy information corresponding to the preset identifier of the first message.

For example, the privacy information may include information with respect to the second user.

For example, the obtaining the first message may comprise, based on the at least one message being longer than a preset length, generating a summarized message to be inputted to the first model, by summarizing the at least one message using a second model different from the first model.

For example, the obtaining the first message may comprise obtaining a third message not including the preset identifier. The displaying the second message may comprise displaying the third message together with the second message.

For example, the second request may include an input to select the second message among the second message and the third message.

As described above, in an embodiment, a non-transitory computer-readable storage medium for storing instructions may be provided. The instructions, when executed by an electronic device including memory, may cause the electronic device to identify a user request. The instructions, when executed by the electronic device, may cause the electronic device to generate a response with respect to the user request, and generate a prompt to replace inaccessible information to be included in the response with a keyword. The instructions, when executed by the electronic device, may cause the electronic device to provide the prompt to a trained model in the electronic device configured to be able to access, a first storage area of the memory. The instructions, when executed by the electronic device, may cause the electronic device to obtain a first response generated according to the prompt, from the trained model. The instructions, when executed by the electronic device, may cause the electronic device to generate a second response by replacing the keyword included in the first response with privacy information in a second storage area of the memory.

For example, the instructions, when executed by the electronic device comprising a display, may cause the electronic device to identify the user request through a messenger screen displayed on the display. The instructions, when executed by the electronic device, may cause the electronic device to generate the prompt including a plurality of text messages able to be displayed in the messenger screen.

For example, the instructions, when executed by the electronic device comprising communication circuitry, may cause the electronic device to display the second response in the messenger screen. The instructions, when executed by the electronic device, may cause the electronic device to, based on identifying a transmission request with respect to the second response, transmit the second response to an external electronic device through the communication circuitry.

In an embodiment, a non-transitory computer-readable storage medium for storing instructions may be provided. The instructions, when executed by an electronic device including memory, may cause the electronic device to perform operations. The operations may include providing a chatting session in which at least one message exchanged between a first user of the electronic device and a second user of another electronic device is displayed, in response to a first request, obtaining a first message to be transmitted to the another electronic device from a first model, by inputting the at least one message to the first model set to generate character strings based on the provided input, at least based on determination that the first message includes a preset identifier, displaying a second message in which the preset identifier is replaced with privacy information stored in the electronic device, and in response to a second request, transmitting to the another electronic device the second message through the chatting session.

For example, the first model may comprise a model trained with restricted access to privacy information, the privacy information may include personal information unique to the first user.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the scope of the disclosure as defined by the appended claims and their equivalents.

What is claimed is

1. An electronic device comprising:
memory, comprising one or more storage media, storing instructions; and
at least one processor including processing circuitry, the at least one processor communicatively coupled to the memory,
wherein the instructions, when executed by the at least one processor individually or collectively, cause the electronic device to:
identify an event for generating a response,
based on identifying the event, generate a prompt to replace information associated with a second storage area different from a first storage area of the memory, with a keyword,
provide the prompt to a trained model in the electronic device configured to be able to access, among the first storage area or the second storage area of the memory, the first storage area,
obtain a first response generated according to the prompt, from the trained model, and
generate a second response by replacing the keyword included in the first response with privacy information in the second storage area of the memory.

2. The electronic device of claim 1, further comprising:
a display,
wherein the instructions, when executed by the at least one processor individually or collectively, further cause the electronic device to:
identify a user request through a messenger screen displayed on the display, and
generate the prompt including a plurality of text messages able to be displayed in the messenger screen.

3. The electronic device of claim 2, further comprising:
communication circuitry,
wherein the instructions, when executed by the at least one processor individually or collectively, further cause the electronic device to:
display, on the display, the second response, and
based on identifying a transmission request with respect to the second response, transmit the second response to an external electronic device through the communication circuitry.

4. The electronic device of claim 3, wherein the instructions, when executed by the at least one processor individually or collectively, further cause the electronic device to:
identify, through the second response displayed on the display, an editing request with respect to the privacy information that is included in the second response, and
based on identifying the editing request, display a pop-up window of a software application associated with the privacy information superimposed on the messenger screen on the display.

5. The electronic device of claim 1, wherein the instructions, when executed by the at least one processor individually or collectively, further cause the electronic device to:
generate the second response by searching for the privacy information included in at least one of:
calendar database,
messenger database,
contact database, or
wallet database,
which are associated with a user of the electronic device.

6. The electronic device of claim 5, wherein the instructions, when executed by the at least one processor individually or collectively, further cause the electronic device to:
generate the prompt including the keyword such that the first response does not include texts different from information stored in the calendar database.

7. The electronic device of claim 1, wherein the instructions, when executed by the at least one processor individually or collectively, further cause the electronic device to:
generate the prompt to output a list of the keyword included in the first response, together with the first response.

8. An electronic device comprising:
memory, comprising one or more storage media, storing instructions; and
at least one processor including processing circuitry, the at least one processor communicatively coupled to the memory,
wherein the instructions, when executed by the at least one processor individually or collectively, cause the electronic device to:
provide a chatting session in which at least one message exchanged between a first user of the electronic device and a second user of another electronic device is displayed,
in response to a first request, obtain a first message to be transmitted to the another electronic device from a first model, by inputting the at least one message to the first model set to generate character strings based on the provided input,
at least based on determination that the first message includes a preset identifier, display a second message in which the preset identifier is replaced with privacy information stored in the electronic device, and
in response to a second request, transmit, to the another electronic device, the second message through the chatting session.

9. The electronic device of claim 8, wherein the preset identifier corresponds to one of a plurality of identifiers which are provided for the first model together with the at least one message.

10. The electronic device of claim 8, wherein the preset identifier includes a combination of texts which are changed with respect to the privacy information, and a symbol which is not changed with respect to the privacy information.

11. The electronic device of claim 8,
wherein the first message includes at least one sentence including a portion corresponding to the preset identifier, and
wherein the instructions, when executed by the at least one processor individually or collectively, further cause the electronic device to:
identify a type of the privacy information using the preset identifier, and
identify the privacy information using a remaining portion of the at least one sentence and the identified type.

12. The electronic device of claim 8, wherein the instructions, when executed by the at least one processor individually or collectively, further cause the electronic device to:
display the first message before displaying the second message; and
based on an input with respect to the preset identifier included in the first message, change the preset identifier to the privacy information.

13. The electronic device of claim 12, wherein the instructions, when executed by the at least one processor individually or collectively, further cause the electronic device to:
in response to the input, display a visual object such that the first user is able to select the privacy information corresponding to the preset identifier of the first message.

14. The electronic device of claim 8, wherein the privacy information includes information with respect to the second user.

15. The electronic device of claim 8, wherein the instructions, when executed by the at least one processor individually or collectively, further cause the electronic device to:
based on the at least one message being longer than a preset length, generate a summarized message to be inputted to the first model, by summarizing the at least one message using a second model different from the first model.

16. The electronic device of claim 8, wherein the instructions, when executed by the at least one processor individually or collectively, further cause the electronic device to:
obtain a third message not including the preset identifier; and
display the third message together with the second message.

17. The electronic device of claim 16, wherein the second request includes an input to select the second message from among the second message and the third message.

18. A method performed by an electronic device, the method comprising:
providing a chatting session in which at least one message exchanged between a first user of the electronic device and a second user of another electronic device is displayed;
in response to a first request, obtaining a first message to be transmitted to the another electronic device from a first model, by inputting the at least one message to the first model set to generate character strings based on the provided input;
at least based on determination that the first message includes a preset identifier, displaying a second message in which the preset identifier is replaced with privacy information stored in the electronic device; and
in response to a second request, transmitting to the another electronic device the second message through the chatting session.

19. The method of claim 18, wherein the first model comprises a model trained with restricted access to privacy information, the privacy information including personal information unique to the first user.

20. The method of claim 19, wherein the preset identifier includes a keyword that is replaced by a processor of the electronic device with privacy information, the processor having access to the privacy information that the first model does not.
